(19) United States
(12) Patent Application Publication
(10) Pub. No.: US 2025/0317682 A1
(43) Pub. Date: Oct. 9, 2025

(54) HEADPHONE SOUND EFFECT COMPENSATION METHOD AND HEADPHONE SOUND EFFECT COMPENSATION APPARATUS

(71) Applicant: HONOR DEVICE CO., LTD., Shenzhen (CN)

(72) Inventors: Xiao Yang, Shenzhen (CN); Rongrong Gao, Shenzhen (CN); Yuanyou Wu, Shenzhen (CN); Jianfei Chu, Shenzhen (CN)

(21) Appl. No.: 18/881,611

(22) PCT Filed: Oct. 11, 2023
(86) PCT No.: PCT/CN2023/123903

§ 371 Date: Jan. 6, 2025

(30) Foreign Application Priority Data
Dec. 29, 2022 (CN) 202211712424.1

(51) Int. Cl. H04R 1/10

(52) U.S. Cl. CPC H04R 1/1083; H04R 1/1041

(57) ABSTRACT

If the electronic device has a headphone sound effect compensation function, the headphone sends first information to the electronic device, where the first information indicates that the headphone has a capability of reporting the headphone sound effect compensation parameter; the electronic device sends second information to the headphone based on the first information, where the second information is used to request the headphone sound effect compensation parameter; the headphone receives the second information, and sends, based on the first information, the headphone sound effect compensation parameter to the electronic device; and the electronic device receives the headphone sound effect compensation parameter; and performs, based on the headphone sound effect compensation parameter in response to an operation of triggering playing audio by a user, headphone sound effect compensation on the audio played by the user.

### CROSS-REFERENCE TO RELATED APPLICATIONS

This application is a National Stage of International Application No. PCT/CN2023/123903, filed on Oct. 11, 2023, which claims priority to Chinese Patent Application No. 202211712424.1, filed on Dec. 29, 2022, both of which are hereby incorporated by reference in their entireties.

### TECHNICAL FIELD

This application relates to the field of headphone technologies, and in particular, to a headphone sound effect compensation method and a headphone sound effect compensation apparatus.

### BACKGROUND

An electronic device may perform sound effect rendering on audio data to create good hearing experience for a user. With the continuous development of headphones, the user usually uses the headphone to play audio of the electronic device. In this scenario, the electronic device may add a compensation parameter of the headphone when performing sound effect rendering on audio data, to ensure that the audio outputted by the headphone has a good sound effect, to ensure sound effect experience of the user.

Currently, a common headphone sound effect compensation method is that the electronic device stores a universal headphone sound effect compensation parameter. When detecting that the headphone plays the audio, the electronic device performs headphone sound effect compensation on sound effect data by using the universal headphone sound effect compensation parameter. This implementation has a relatively poor headphone sound effect compensation effect.

### SUMMARY

This application provides a headphone sound effect compensation method and a headphone sound effect compensation apparatus, which are beneficial to improving a headphone sound effect compensation effect.

According to a first aspect, a headphone sound effect compensation method is provided. The method is applied to a headphone. The headphone is in a connected state with an electronic device. The headphone stores a headphone sound effect compensation parameter corresponding to the headphone. The method includes: The headphone sends the headphone sound effect compensation parameter to the electronic device if the electronic device has a headphone sound effect compensation function, where the headphone sound effect compensation parameter is used to perform headphone sound effect compensation on audio played by a user.

The headphone may be a pair of headphones or may be one headphone. This is not limited in this application. If the headphone is one headphone, the headphone may be a left headphone or a right headphone. If the headphone is a pair of headphones, a left headphone stores a corresponding headphone sound effect compensation parameter thereof, and a right headphone also stores a corresponding headphone sound effect compensation parameter thereof. The headphone sound effect compensation parameters stored in the left headphone and the right headphone are different.

The headphone may determine, according to a communication instruction, whether the electronic device has the headphone sound effect compensation function. The headphone may send the headphone sound effect compensation parameter to the electronic device if the electronic device has the headphone sound effect compensation function, so that the electronic device performs headphone sound effect compensation on the audio played by the user. If the electronic device does not have the headphone sound effect compensation function, the headphone may perform headphone sound effect compensation based on a stored uncrewed aerial vehicle sound effect compensation parameter.

According to the headphone sound effect compensation method provided in this application, the headphone stores the headphone sound effect compensation parameter, and when performing sound effect compensation on the headphone, the electronic device may perform headphone sound effect compensation on the audio by using the headphone sound effect compensation parameter stored in the headphone, and may perform headphone sound effect compensation on the audio by using different headphone sound effect compensation parameters for different headphones. This is beneficial to improving a headphone sound effect compensation effect.

With reference to the first aspect, in some implementations of the first aspect, before the headphone sends the headphone sound effect compensation parameter to the electronic device, the method further includes: The headphone sends first information to the electronic device, where the first information indicates that the headphone has a capability of reporting the headphone sound effect compensation parameter; and the headphone receives second information from the electronic device, where the second information is used to request the headphone sound effect compensation parameter.

The headphone may inform, through the first information, that the headphone has the capability of reporting the headphone sound effect compensation parameter, so that the electronic device requests, based on the first information, the headphone compensation parameter from the headphone through the second information.

Optionally, before the headphone may inform, through the first information, that the headphone has the capability of reporting the headphone sound effect compensation parameter, the electronic device may further query the headphone for whether the headphone has a capability of reporting data. If the headphone has the capability of reporting the headphone sound effect compensation parameter, the electronic device may send the second information to the headphone to obtain the headphone sound effect compensation parameter stored in the headphone.

In a method shown in FIG. 6 in a specific embodiment, an electronic device may send an information reporting capability query command to a headphone, to query whether the headphone has a capability of reporting a headphone sound effect compensation parameter. An information reporting capability response may represent the foregoing first information, and indicate that the headphone has the capability of reporting the headphone sound effect compensation parameter. An existing-information reporting command may be used to represent the foregoing second information, to be used to obtain the headphone sound effect compensation parameter stored in the headphone.

According to the headphone sound effect compensation method provided in this application, before obtaining the headphone sound effect compensation parameter of the headphone from the headphone, the electronic device first asks the headphone for a capability of reporting information, and indicates the headphone to report the headphone sound effect compensation parameter based on the capability of the headphone to report information. This is beneficial to obtaining the headphone sound effect compensation parameter of the headphone within a headphone reporting capability scope and avoiding invalid indication.

With reference to the first aspect, in some implementations of the first aspect, that the electronic device has the headphone sound effect compensation function includes: The headphone sends a first command to the electronic device, where the first command is used to query whether the electronic device has the headphone sound effect compensation function.

The headphone may query, through the first command, whether the electronic device has the headphone sound effect compensation function, to determine whether to perform headphone sound effect compensation on the audio. It may be understood that if the electronic device has the headphone sound effect compensation function, the headphone may send the headphone sound effect compensation parameter to the electronic device, and the electronic device performs headphone sound effect compensation; and if the electronic device does not have the headphone sound effect compensation function, the headphone may perform headphone sound effect compensation based on the headphone sound effect compensation parameter.

If the electronic device has the headphone sound effect compensation function, the electronic device may send a response to the headphone according to the first command. If the electronic device does not have the headphone sound effect compensation function, the electronic device may not respond or may send indication information indicating that the electronic device does not have the headphone sound effect compensation function. This is not limited in this application.

According to the headphone sound effect compensation method provided in this application, whether the electronic device has the headphone sound effect compensation function is determined according to the first command. This is beneficial to subsequently determining a headphone sound effect compensation solution.

With reference to the first aspect, in some implementations of the first aspect, that the headphone sends the headphone sound effect compensation parameter to the electronic device includes: The headphone sends the headphone sound effect compensation parameter to the electronic device if a first control is in an on state, where the first control is configured to control enabling or disabling of the headphone sound effect compensation function.

The first control may be referred to as a headphone sound effect compensation function control or a headphone-targeted compensation control. This is not limited in this application. The first control may be in the on state by default, or may be in the on state based on an opening operation of the user. This is not limited in this application.

When the first control is in the on state, the headphone may send the headphone sound effect compensation parameter to the electronic device so that the electronic device performs, based on the headphone sound effect compensation parameter, headphone sound effect compensation on the audio played by the user. If the first control is in an off state, the headphone may not send the headphone sound effect compensation parameter to the electronic device, and the electronic device does not perform, based on the headphone sound effect compensation parameter, headphone sound effect compensation on the audio played by the user.

According to the headphone sound effect compensation method provided in this application, when the first control is in the on state, the headphone may send the headphone sound effect compensation parameter to the electronic device, and the electronic device may perform, based on the headphone sound effect compensation parameter, headphone sound effect compensation on the audio played by the user, and may perform, based on a requirement, headphone sound effect compensation on the audio played by the user. This is beneficial to improving user experience.

With reference to the first aspect, in some implementations of the first aspect, the method further includes: The headphone receives third information from the electronic device, where the third information is used to request head motion tracking data, and the head motion tracking data is used to perform sound effect rendering on the audio; and the headphone sends the head motion tracking data to the electronic device based on the third information.

The electronic device may not calculate the head motion tracking data of the user, and may directly obtain the head motion tracking data from the headphone. Specifically, the electronic device sends the third information to the headphone, where the third information is used to request the head motion tracking data; and the electronic device receives the head motion tracking data from the headphone. The third information and the foregoing second information may be the same piece of information or may be different pieces of information. This is not limited in this application. The headphone may calculate the head motion tracking data based on motion data of the headphone. The headphone may include an inertial measurement unit (inertial measurement unit, IMU) sensor and an IMU driver, to obtain the motion data of the headphone.

According to the headphone sound effect compensation method provided in this application, the electronic device does not need to calculate the head motion tracking data of the user. This can save a calculation capability of the electronic device.

With reference to the first aspect, in some implementations of the first aspect, the method further includes: The headphone receives fourth information from the electronic device, where the fourth information is used to request angular velocity data and acceleration data of the headphone, and the angular velocity data and the acceleration data are used to perform sound effect rendering on the audio; and the headphone sends the angular velocity data and the acceleration data to the electronic device based on the fourth information.

The electronic device may calculate the head motion tracking data of the user based on motion data of the headphone, and the motion data of the headphone may be obtained from the headphone. Specifically, the electronic device sends the fourth information to the headphone, where the fourth information is used to request the angular velocity data and acceleration data of the headphone; the electronic device receives the angular velocity data and the acceleration data from the headphone; and the electronic device determines the head motion tracking data based on the angular velocity data and the acceleration data. The fourth information and the foregoing second information may be the same piece of information or may be different pieces of information. This is not limited in this application. The headphone may include an IMU sensor and an IMU driver, to obtain the motion data of the headphone.

According to the headphone sound effect compensation method provided in this application, the headphone does not need to calculate the head motion tracking data of the user. This can save a calculation capability of the headphone.

With reference to the first aspect, in some implementations of the first aspect, the method further includes: If the electronic device does not have the headphone sound effect compensation function, the headphone receives the audio from the electronic device, where the audio is obtained by the electronic device in response to the operation of triggering playing the audio by the user; and the headphone performs headphone sound effect compensation on the audio based on the headphone sound effect compensation parameter.

If the electronic device does not have the sound effect compensation function, in response to the operation of triggering playing the audio by the user, the electronic device may not perform any operation on the audio, but directly send, to the headphone, the audio played by the user. The headphone may perform headphone sound effect compensation on the audio based on the headphone sound effect compensation parameter after receiving the audio.

According to the headphone sound effect compensation method provided in this application, the headphone may perform headphone sound effect compensation based on the stored headphone sound effect compensation parameter if the electronic device does not have the sound effect compensation function. This is beneficial to improving a headphone sound effect compensation effect.

According to a second aspect, a headphone sound effect compensation method is provided. The method is applied to an electronic device. The electronic device is in a connected state with a headphone. The headphone stores a headphone sound effect compensation parameter corresponding to the headphone. The method includes: The electronic device receives the headphone sound effect compensation parameter from the headphone if the electronic device has a headphone sound effect compensation function; and the electronic device performs, in response to an operation of triggering playing audio by a user, headphone sound effect compensation on the audio played by the user based on the headphone sound effect compensation parameter.

With reference to the second aspect, in some implementations of the second aspect, before the electronic device receives the headphone sound effect compensation parameter from the headphone, the method further includes: The electronic device receives first information from the headphone, where the first information indicates that the headphone has a capability of reporting the headphone sound effect compensation parameter; and the electronic device sends second information to the headphone based on the first information, where the second information is used to request the headphone sound effect compensation parameter.

With reference to the second aspect, in some implementations of the second aspect, that the electronic device has a headphone sound effect compensation function includes: The electronic device receives a first command from the headphone, where the first command is used to query whether the electronic device has the headphone sound effect compensation function.

With reference to the second aspect, in some implementations of the second aspect, that the electronic device receives the headphone sound effect compensation parameter from the headphone includes: The electronic device receives the headphone sound effect compensation parameter from the headphone if a first control is in an on state, where the first control is configured to control enabling or disabling of the headphone sound effect compensation function.

With reference to the second aspect, in some implementations of the second aspect, the method further includes: The electronic device obtains head motion tracking data of the user in response to the operation of triggering playing the audio by the user; the electronic device obtains relative motion data between the electronic device and a head of the user based on the head motion tracking data; and the electronic device performs, based on the relative motion data between the electronic device and the head of the user, sound effect rendering on the audio played by the user.

Alternatively, the electronic device may obtain head motion tracking data of the user in real time, and obtain relative motion data between the electronic device and a head of the user based on the head motion tracking data and motion data (for example, acceleration data and angular velocity data) of the electronic device; and perform, based on the relative motion data between the electronic device and the head of the user, sound effect rendering on the audio played by the user. The electronic device may include an IMU sensor and an IMU driver, to obtain the motion data of the electronic device.

According to the headphone sound effect compensation method provided in this application, in addition to headphone sound effect compensation performed on the audio, sound effect rendering may further be performed on the audio based on the relative motion data between the electronic device and the head of the user. This is beneficial to improving sound effect experience of the user.

With reference to the second aspect, in some implementations of the second aspect, the obtaining head motion tracking data of the user includes: the electronic device sends the third information to the headphone, where the third information is used to request the head motion tracking data; and the electronic device receives the head motion tracking data from the headphone.

With reference to the second aspect, in some implementations of the second aspect, the obtaining head motion tracking data of the user includes: The electronic device sends the fourth information to the headphone, where the fourth information is used to request the angular velocity data and acceleration data of the headphone; the electronic device receives the angular velocity data and the acceleration data from the headphone; and the electronic device determines the head motion tracking data based on the angular velocity data and the acceleration data.

With reference to the second aspect, in some implementations of the second aspect, the obtaining head motion tracking data of the user includes: The electronic device obtains the head motion tracking data of the user if a second control is in the on state, where the second control is configured to control whether to obtain the head motion tracking data.

The second control may be referred to as a head motion tracking function control or a head motion tracking control. This is not limited in this application. The second control may be in the on state by default, or may be in the on state based on an opening operation of the user. This is not limited in this application.

When the second control is in the on state, the electronic device may calculate the relative motion data of the head of the user relative to the electronic device based on the head motion tracking data of the user, and perform, based on the relative motion data of the head of the user relative to the electronic device, sound effect rendering on the audio played by the user. If the second control is in an off state, the electronic device may not perform sound effect rendering on the audio played by the user.

According to the headphone sound effect compensation method provided in this application, when the second control is in the on state, the head motion tracking data of the user is obtained, the relative motion data of the head of the user relative to the electronic device is calculated based on the head motion tracking data of the user, and sound effect rendering is performed, based on the relative motion data of the head of the user relative to the electronic device, on the audio played by the user. This is beneficial to improving user experience.

With reference to the second aspect, in some implementations of the second aspect, the method further includes: If the electronic device does not have the headphone sound effect compensation function, the electronic device sends, to the headphone in response to the operation of triggering playing the audio by the user, the audio played by the user.

According to a third aspect, a headphone sound effect compensation method is provided. The method is applied to a communication system including an electronic device and a headphone. The electronic device is in a connected state with the headphone. The headphone stores a headphone sound effect compensation parameter corresponding to the headphone. The method includes: If the electronic device has a headphone sound effect compensation function, the headphone sends first information to the electronic device, where the first information indicates that the headphone has a capability of reporting the headphone sound effect compensation parameter; the electronic device sends second information to the headphone based on the first information, where the second information is used to request the headphone sound effect compensation parameter; the headphone receives the second information, and sends, based on the first information, the headphone sound effect compensation parameter to the electronic device; the electronic device receives the headphone sound effect compensation parameter; and the electronic device performs, in response to an operation of triggering playing audio by a user, headphone sound effect compensation on the audio played by the user based on the headphone sound effect compensation parameter.

With reference to the third aspect, in some implementations of the third aspect, the method further includes: If the electronic device does not have the headphone sound effect compensation function, the electronic device sends, to the headphone in response to the operation of triggering playing the audio by the user, the audio played by the user; the headphone receives the audio; and the headphone performs headphone sound effect compensation on the audio based on the headphone sound effect compensation parameter.

According to a fourth aspect, a sound effect compensation apparatus is provided. The sound effect compensation apparatus is in a connected state with an electronic device. The sound effect compensation apparatus stores a sound effect compensation parameter corresponding to the sound effect compensation apparatus. The sound effect compensation apparatus includes a transceiver module. The transceiver module is configured to: send the sound effect compensation parameter to the electronic device if the electronic device has the sound effect compensation function, where the sound effect compensation parameter is used to perform sound effect compensation on audio played by a user.

With reference to the fourth aspect, in some implementations of the fourth aspect, the transceiver module is further configured to: send first information to the electronic device, where the first information indicates that there is a capability of reporting the sound effect compensation parameter; and receive second information from the electronic device, where the second information is used to request the sound effect compensation parameter.

With reference to the fourth aspect, in some implementations of the fourth aspect, the transceiver module is further configured to: send a first command to the electronic device, where the first command is used to query whether the electronic device has the sound effect compensation function.

With reference to the fourth aspect, in some implementations of the fourth aspect, the transceiver module is further configured to: send the sound effect compensation parameter to the electronic device if a first control is in an on state, where the first control is configured to control enabling or disabling of the sound effect compensation function.

With reference to the fourth aspect, in some implementations of the fourth aspect, the transceiver module is further configured to: receive third information from the electronic device, where the third information is used to request head motion tracking data, and the head motion tracking data is used to perform sound effect rendering on the audio; and send the head motion tracking data to the electronic device based on the third information.

With reference to the fourth aspect, in some implementations of the fourth aspect, the transceiver module is further configured to: receive fourth information from the electronic device, where the fourth information is used to request angular velocity data and acceleration data, and the angular velocity data and the acceleration data are used to perform sound effect rendering on the audio; and send the angular velocity data and the acceleration data to the electronic device based on the fourth information.

With reference to the fourth aspect, in some implementations of the fourth aspect, the sound effect compensation apparatus further includes a processing module. The transceiver module is further configured to: receive the audio from the electronic device if the electronic device does not have the sound effect compensation function, where the audio is obtained by the electronic device in response to the operation of triggering playing the audio by the user. The processing module is configured to: perform sound effect compensation on the audio based on the sound effect compensation parameter.

According to a fifth aspect, a headphone sound effect compensation apparatus is provided. The headphone sound effect compensation apparatus is in a connected state with a headphone. The headphone stores a headphone sound effect compensation parameter corresponding to the headphone. The headphone sound effect compensation apparatus includes a transceiver module and a processing module. The transceiver module is configured to: receive the headphone sound effect compensation parameter from the headphone if there is a headphone sound effect compensation function. The processing module is configured to: perform, based on the headphone sound effect compensation parameter in response to the operation of triggering playing the audio by the user, headphone sound effect compensation on the audio played by the user.

With reference to the fifth aspect, in some implementations of the fifth aspect, the transceiver module is further configured to: receive first information from the headphone, where the first information indicates that the headphone has a capability of reporting the headphone sound effect compensation parameter; and send second information to the headphone based on the first information, where the second information is used to request the headphone sound effect compensation parameter.

With reference to the fifth aspect, in some implementations of the fifth aspect, the transceiver module is further configured to: receive a first command from the headphone, where the first command is used to query whether there is the headphone sound effect compensation function.

With reference to the fifth aspect, in some implementations of the fifth aspect, the transceiver module is further configured to: receive the headphone sound effect compensation parameter from the headphone if the first control is in an on state, where the first control is configured to control enabling or disabling of the headphone sound effect compensation function.

With reference to the fifth aspect, in some implementations of the fifth aspect, the transceiver module is further configured to: obtain head motion tracking data of the user in response to the operation of triggering playing the audio by the user. The processing module is further configured to: obtain relative motion data to a head of the user based on the head motion tracking data; and perform, based on the relative motion data to the head of the user, sound effect rendering on the audio played by the user.

With reference to the fifth aspect, in some implementations of the fifth aspect, the transceiver module is further configured to: send third information to the headphone, where the third information is used to request the head motion tracking data; and receive the head motion tracking data from the headphone.

With reference to the fifth aspect, in some implementations of the fifth aspect, the transceiver module is further configured to: send fourth information to the headphone, where the fourth information is used to request angular velocity data and acceleration data of the headphone; receive the angular velocity data and the acceleration data from the headphone; and determine the head motion tracking data based on the angular velocity data and the acceleration data.

With reference to the fifth aspect, in some implementations of the fifth aspect, the transceiver module is further configured to: obtain the head motion tracking data of the user if a second control is in the on state, where the second control is configured to control whether to obtain the head motion tracking data.

With reference to the fifth aspect, in some implementations of the fifth aspect, the transceiver module is further configured to: if there is no headphone sound effect compensation function, send, to the headphone in response to the operation of triggering playing the audio by the user, the audio played by the user.

According to a sixth aspect, this application provides a headphone sound effect compensation apparatus. The headphone sound effect compensation apparatus includes: a processor and a memory. The memory stores computer-executable instructions. The processor executes the computer-executable instructions stored in the memory, to enable the headphone sound effect compensation apparatus to perform each of the methods according to each of the foregoing aspects. According to a seventh aspect, this application provides a computer-readable storage medium. The computer-readable storage medium stores a computer program. The computer program, when executed by a processor, implements each of the methods according to each of the foregoing aspects.

According to an eighth aspect, this application provides a computer program product. The computer program product includes a computer program. The computer program, when being run, enables a computer to perform each of the methods according to each of the foregoing aspects.

According to a ninth aspect, this application provides a chip. The chip includes a processor. The processor is configured to invoke a computer program in a memory to perform each of the methods according to each of the foregoing aspects.

### BRIEF DESCRIPTION OF DRAWINGS

FIG. 1 is a diagram of playing audio of an electronic device through a headphone;

FIG. 2 is a block diagram of a headphone sound effect compensation method;

FIG. 3 is a diagram of a measurement system of a headphone sound effect compensation parameter according to an embodiment of this application;

FIG. 4 is a schematic flowchart of a measurement method of a headphone sound effect compensation parameter according to an embodiment of this application;

FIG. 5 is a block diagram of a headphone sound effect compensation method according to an embodiment of this application;

FIG. 6 is a schematic flowchart of a communication method according to an embodiment of this application;

FIG. 7 is a schematic flowchart of another communication method according to an embodiment of this application;

FIG. 8A, FIG. 8B, FIG. 8C, and FIG. 8D are a diagram of a function interface according to an embodiment of this application;

FIG. 9 is a block diagram of another headphone sound effect compensation method according to an embodiment of this application;

FIG. 10 is a diagram of another function interface according to an embodiment of this application;

FIG. 11 is a diagram of still another headphone sound effect compensation method according to an embodiment of this application;

FIG. 12A, FIG. 12B, FIG. 12C, and FIG. 12D are a diagram of still another function interface according to an embodiment of this application;

FIG. 13 is a schematic flowchart of a headphone sound effect compensation solution selection method according to an embodiment of this application;

FIG. 14 is a block diagram of a headphone sound effect compensation apparatus according to an embodiment of this application; and

FIG. 15 is a block diagram of another headphone sound effect compensation apparatus according to an embodiment of this application.

### DESCRIPTION OF EMBODIMENTS

The following describes technical solutions of this application with reference to accompanying drawings.

An electronic device may perform sound effect rendering on audio data to create good hearing experience for a user. With the continuous development of headphones, a user usually uses the headphone to play audio of an electronic device. In this scenario, the electronic device needs to add a compensation parameter of the headphone when performing sound effect rendering on audio data, to ensure that the audio outputted by the headphone has a good sound effect, to ensure sound effect experience of the user.

Currently, a common headphone sound effect compensation method is that the electronic device stores a universal headphone sound effect compensation parameter. When detecting that the headphone plays audio, the electronic device performs headphone sound effect compensation on sound effect data by using the universal headphone sound effect compensation parameter. However, there is a difference between headphones of different models, between headphones of a same model but with different serial numbers, or between left and right headphones in a pair of headphones. If the electronic device performs headphone sound effect compensation on the audio data by using the universal headphone sound effect compensation parameter, a poor sound effect compensation effect is caused, and further sound effect experience of the user is affected.

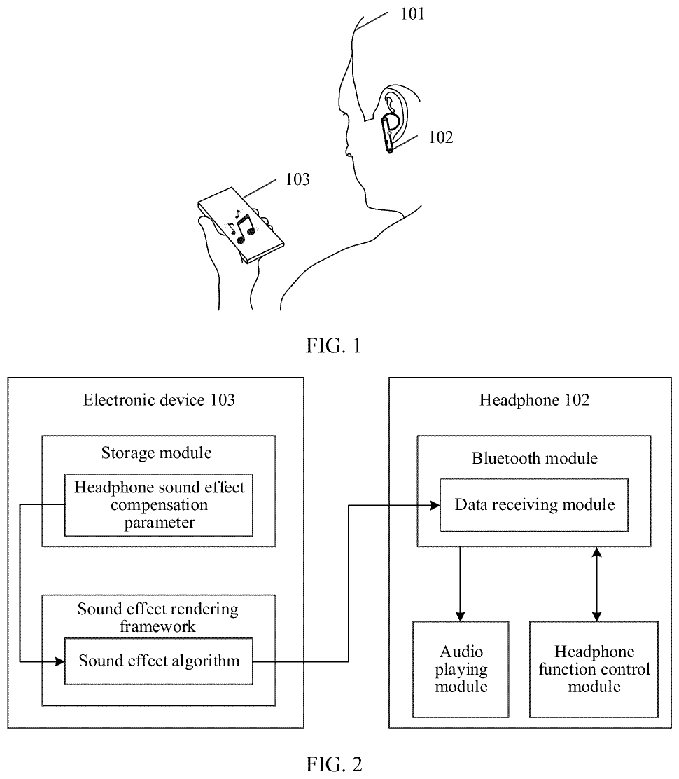

For example, FIG. 1 is a diagram of playing audio of an electronic device through a headphone. As shown in FIG. 1, a user 101 wears a headphone 102. The headphone 102 is in a connected state with an electronic device 103. The headphone 102 may transmit collected sound to the electronic device 103, or may receive audio data from the electronic device 103, and play audio corresponding to the audio data.

The electronic device 103 stores a universal headphone sound effect compensation parameter. When the electronic device 103 detects an operation of triggering playing music by the user 101, in response to the operation, the electronic device 103 may perform sound effect compensation on music data based on the universal headphone sound effect compensation parameter, perform sound effect rendering on the music data, and transmit the music data after the sound effect rendering to the headphone 102. The headphone 102 receives the music data after the sound effect rendering, and plays music corresponding to the music data after the sound effect rendering.

Sound effect compensation refers to adjusting a phase frequency (or referred to as a phase) and an amplitude frequency (or referred to as an amplitude) of audio. Sound effect rendering refers to processing an effect of audio, for example, processing such as presence audio, noise reduction, and head motion tracking.

To better understand the headphone sound effect compensation method in FIG. 1, the method is described in detail in embodiments of this application.

FIG. 2 is a block diagram of a headphone sound effect compensation method. As shown in FIG. 2, a headphone 102 includes a Bluetooth module, an audio playing module, and a headphone function control module. The Bluetooth module is configured to perform Bluetooth communication with an electronic device 103. The Bluetooth module includes a data receiving module. The data receiving module is configured to receive audio data from the electronic device 103 through a Bluetooth technology. The audio playing module is configured to play audio corresponding to the audio data. The headphone function control module is configured to store states of functions supported by the headphone. For example, the headphone supports a sound effect rendering mode, and the headphone function control module includes an on or off state of the sound effect rendering mode.

The electronic device 103 includes a storage module and a sound effect rendering framework. The storage module stores the headphone sound effect compensation parameter. The headphone sound effect compensation parameter is universal, that is, may be used to represent a compensation parameter of any headphone. The sound effect rendering framework includes a sound effect algorithm, and is used to perform sound effect rendering on the audio data.

The electronic device 103 is in a connected state with the headphone 102, and the sound effect rendering mode of the headphone 102 is in the on state. When the electronic device 103 detects an operation of triggering playing music by the user 101, in response to the operation, the electronic device 103 may obtain the universal headphone sound effect compensation parameter from the storage module, input the universal headphone sound effect compensation parameter into the sound effect algorithm to perform headphone sound effect compensation on music data, render the music data based on the sound effect algorithm to obtain music data after sound effect rendering, and send the music data after the sound effect rendering to the headphone 102. The headphone 102 receives, through the data receiving module, the music data after the sound effect rendering, and plays, through the audio playing module, music corresponding to the music data after the sound effect rendering.

In this implementation, for headphones of different models, headphones of a same model but with different serial numbers, or left and right headphones in a pair of headphones, the electronic device 103 performs headphone sound effect compensation on the music data by using the universal headphone sound effect compensation parameter. Consequently, a relatively poor sound effect compensation effect is caused, and further sound effect experience of the user is affected.

If an electronic device, for example, the electronic device 103, stores a corresponding headphone sound effect compensation parameter thereof based on a model or a serial number of the headphone, to create good hearing experience for the user, the following problems may exist.

(1) There are a relatively large quantity of stored headphone sound effect compensation parameters, which occupy relatively large storage space of the electronic device, and are more difficult to apply to an actual product.

(2) Flexibility is relatively poor. When the electronic device is connected to a headphone with a new model or a new serial number, the electronic device does not store a headphone sound effect compensation parameter corresponding to the headphone, and it cannot be ensured that audio outputted by the headphone has a good sound effect.

(3) There are a relatively large quantity of stored headphone sound effect compensation parameters, but there are both a relatively small quantity of types of headphones and a relatively small quantity of headphones actually used by the user. Consequently, most of the stored headphone sound effect compensation parameters have a relatively low usage rate, resulting in waste of resources.

In addition, the headphone sound effect compensation parameter stored in the electronic device is for compensation for a pair of headphones, and there is also a difference between headphones in the pair of headphones. Currently, the electronic device cannot perform sound effect compensation for each headphone.

In view of this, embodiments of this application provide a headphone sound effect compensation method and a headphone sound effect compensation apparatus. Each headphone stores a corresponding headphone sound effect compensation parameter thereof. If the headphone is connected to an electronic device having a sound effect rendering function, when the electronic device detects an operation of playing audio by a user, the electronic device may obtain the headphone sound effect compensation parameter of the headphone from the headphone, and perform headphone sound effect compensation on audio data based on the headphone sound effect compensation parameter of the headphone. This is beneficial to improving a headphone sound effect compensation effect, and further improves sound effect experience of the user.

The method provided in embodiments of this application is applicable to any electronic device that may play audio through a headphone. The electronic device may be, for example, a mobile phone, a tablet computer, a television, a personal computer (personal computer, PC), or a wearable device such as a smartwatch, may be various teaching aids (such as a learning machine and an early education machine), a smart toy, a portable robot, a personal digital assistant (personal digital assistant, PDA), an augmented reality (augmented reality, AR) device, and a virtual reality (virtual reality, VR) device, or the like, or may be a device that has a mobile office function, a device that has a smart household function, a device that has a video and audio entertainment function, a device that supports intelligent transportation, or the like. It should be understood that embodiments of this application impose no limitation on a specific technology and a specific device form that are used by the terminal device.

For ease of describing the technical solutions in embodiments of this application clearly, in embodiments of this application, terms such as “first” and “second” are used to distinguish between same or similar items with a basically same function and role. A person skilled in the art may understand that the terms such as “first” and “second” do not limit a quantity and an execution sequence, and the terms such as “first” and “second” are not limited to be necessarily different.

It should be noted that in embodiments of this application, terms such as “exemplary” and “for example” are used to represent giving an example, an illustration, or a description. Any embodiment or design scheme described as “exemplary” or “for example” in this application should not be explained as being more preferred or having more advantages than another embodiment or design scheme. Exactly, use of the terms such as “exemplary” and “example” is intended to present a related concept in a specific implementation.

In embodiments of this application, “at least one” refers to one or more, and “a plurality of” refers to two or more. The term “and/or” is an association relationship for describing associated objects and represents that three relationships may exist. For example, A and/or B may represent: Only A exists, both A and B exist, and only B exists, where A and B may be singular or plural. The character “/” generally indicates an “or” relationship between the associated objects. “At least one of the following items (pieces)” or a similar expression means any combination of these items, including a single item (piece) or any combination of a plurality of items (pieces). For example, at least one of a, b, or c may represent: a, b, c, a-b, a-c, b-c, or a-b-c, where a, b, and c may be single or multiple.

The following describes the technical solutions of this application and how to resolve the foregoing technical problems according to the technical solutions of this application in detail by using specific embodiments. The following several specific embodiments may be independently implemented, and may also be combined with each other, and the same or similar concepts or processes may not be described repeatedly in some embodiments.

Embodiments of this application provide a headphone sound effect compensation parameter measurement method, which is beneficial to enabling each headphone to store a corresponding headphone sound effect compensation parameter thereof.

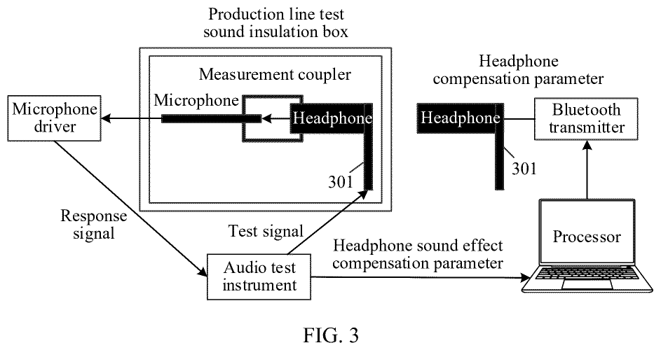

For example, FIG. 3 is a diagram of a headphone sound effect compensation parameter measurement system. As shown in FIG. 3, the measurement system includes a processor, a Bluetooth transmitter, an audio test instrument, a production line test sound insulation box, a microphone driver, and one headphone 301 (which may also be referred to as a to-be-tested headphone). The processor is a device having a processing function. The processor may be separately connected to the Bluetooth transmitter and the audio test instrument through a universal serial bus (universal serial bus, USB). The production line test sound insulation box includes a microphone and a measurement coupler. The headphone 301 may be located in the production line test sound insulation box, so that a headphone sound effect compensation parameter of the headphone 301 is measured. The microphone driver may alternatively be replaced with an amplifier. This is not limited in this embodiment of this application.

When the headphone 301 is in the production line test sound insulation box, the audio test instrument is configured to generate a test signal and transmit the test signal to the headphone 301. The microphone is configured to collect sound played by the headphone 301. The microphone driver is configured to amplify the sound collected by the microphone and output a response signal. The audio test instrument is configured to calculate the headphone sound effect compensation parameter based on the test signal and the response signal. When the headphone 301 is not located in the production line test sound insulation box, the processor may be configured to obtain the headphone sound effect compensation parameter from the audio test instrument, and write the headphone sound effect compensation parameter into the headphone 301 through the Bluetooth transmitter.

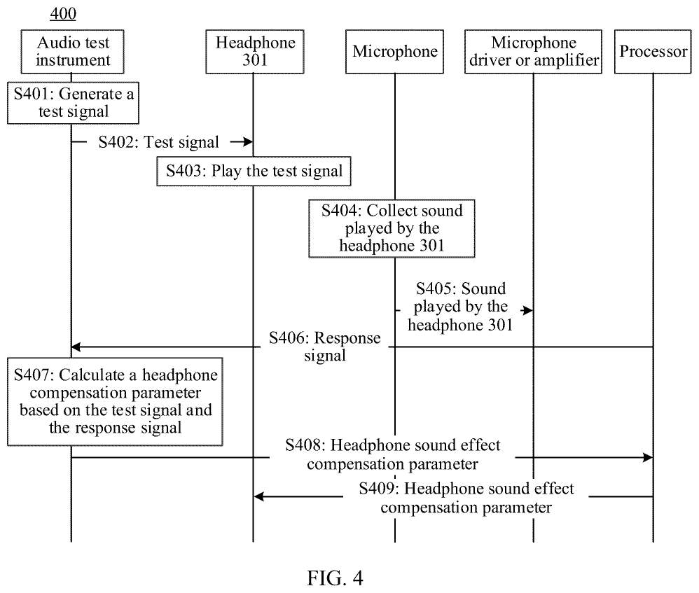

For example, FIG. 4 is a schematic flowchart of a headphone sound effect compensation parameter measurement method 400. The method 400 is applicable to the test system described in FIG. 3.

As shown in FIG. 4, the method 400 may include the following steps.

S401: An audio test instrument generates a test signal, where the test signal may be represented by a symbol H₁(jw).

S402: The audio test instrument may send the test signal H₁(jw) to a headphone 301 through a Bluetooth transmitter based on a Bluetooth audio transmission protocol (advanced audio distribution profile, A2DP), and correspondingly, the headphone 301 receives the test signal H₁(jw).

S403: The headphone 301 plays the test signal H₁(jw).

S404: A microphone collects sound played by the headphone 301, and transmits the sound played by the headphone 301 to a microphone driver or an amplifier.

S405: The microphone driver or the amplifier amplifies the sound played by the headphone 301, and outputs a response signal H₂(jw).

S406: The microphone driver or the amplifier may transmit the response signal H₂(jw) to the audio test instrument.

S407: The audio test instrument calculates a headphone sound effect compensation parameter based on the test signal H₁(jw) and the response signal H₂(jw), where the headphone sound effect compensation parameter may include an amplitude-frequency compensation parameter and a phase-frequency compensation parameter.

S408: The audio test instrument may transmit the headphone sound effect compensation parameter to a processor, and correspondingly, the processor receives the headphone sound effect compensation parameter.

S409: The processor may write the headphone sound effect compensation parameter into the headphone 301 through the Bluetooth transmitter.

According to the headphone sound effect compensation parameter measurement method provided in this embodiment of this application, for each headphone, a corresponding headphone sound effect compensation parameter thereof may be measured. This is beneficial to subsequently performing sound effect compensation for each headphone, so that a sound effect of each headphone is improved. In addition, in this method, the compensation parameter corresponding to each headphone is stored in the corresponding headphone, and the headphone is connected to an electronic device. This is beneficial to performing headphone sound effect compensation on audio data based on the headphone sound effect compensation parameter stored in the headphone, and helps the headphone output audio that has a good sound effect.

Each headphone in this embodiment of this application stores a headphone sound effect compensation parameter. Based on this, the headphone sound effect compensation method provided in this embodiment of this application is described in detail. It may be understood that, a role of the headphone sound effect compensation parameter is to perform headphone compensation or headphone sound effect compensation on the audio data. The headphone sound effect compensation may also be referred to as headphone-targeted compensation. This is not limited in this embodiment of this application.

In different scenarios, the headphone sound effect compensation method provided in this embodiment of this application varies. In this embodiment of this application, description is provided by using an example in which headphone sound effect compensation is performed on one headphone. If the headphone is a pair of headphones, the electronic device may separately perform headphone sound effect compensation on a left headphone and a right headphone of the pair of headphones according to the method provided in this embodiment of this application.

### Embodiment 1

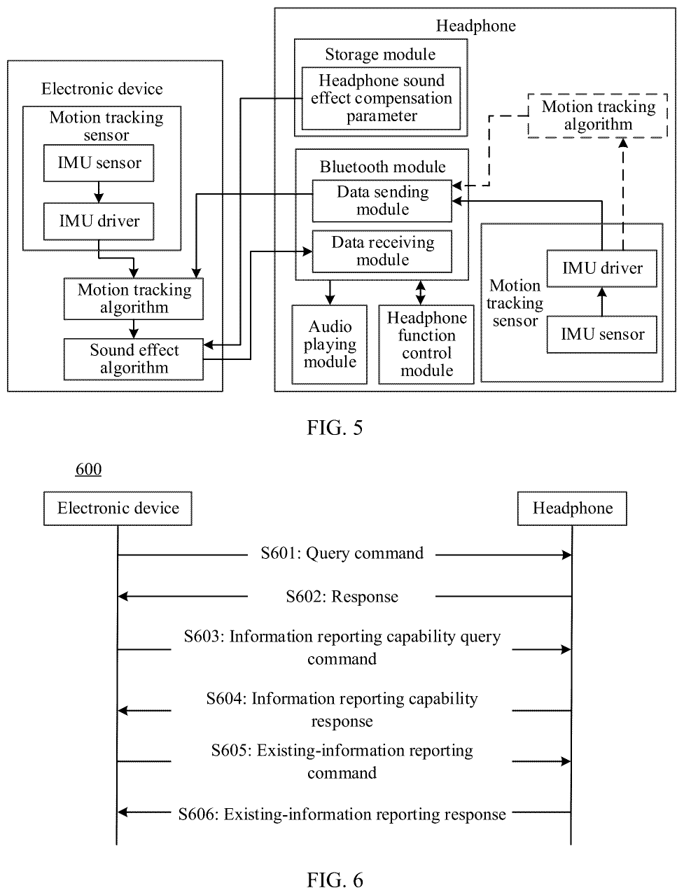

FIG. 5 is a block diagram of a headphone sound effect compensation method according to an embodiment of this application. As shown in FIG. 5, an electronic device is in a connected state with a headphone. The headphone may be a left headphone of a pair of headphones or a right headphone of the pair of headphones. This is not limited in this embodiment of this application. The headphone may support communication with the electronic device through an agreed command. The electronic device has a sound effect rendering capability and a sound effect compensation capability.

The headphone may include a storage module, a motion tracking sensor, a motion tracking algorithm, a Bluetooth module, an audio playing module, and a headphone function control module. The storage module stores a headphone sound effect compensation parameter, where the headphone sound effect compensation parameter may be obtained based on the method shown in FIG. 4. The motion tracking sensor includes an inertial measurement unit (inertial measurement unit, IMU) sensor and an IMU driver, to obtain motion data of the headphone (for example, an acceleration and an angular velocity of the headphone), to calculate head motion tracking data of a user (for example, a displacement and an angle of a head motion of the user). The motion tracking algorithm is used to calculate the head motion tracking data of the user based on the motion data of the headphone. The Bluetooth module is configured to perform Bluetooth communication with the electronic device. The Bluetooth module includes a data receiving module and a data sending module. The data receiving module is configured to receive audio data from the electronic device through a Bluetooth technology. The data sending module is configured to send the motion data of the headphone or the head motion tracking data of the user to the electronic device through the Bluetooth technology. The audio playing module is configured to play audio corresponding to the audio data. The headphone function control module is configured to store states of functions supported by the headphone. For example, a sound effect function of the headphone supports headphone-targeted compensation and head motion tracking. The headphone function control module includes an enabling or disabling state of the headphone-targeted compensation and an enabling or disabling state of the head motion tracking. It should be noted that the motion tracking algorithm in the headphone is optional.

The electronic device includes a motion tracking sensor, a motion tracking algorithm, and a sound effect algorithm. The motion tracking sensor includes an IMU sensor and an IMU driver, to obtain motion data of the electronic device (for example, an acceleration and an angular velocity of the electronic device). The motion tracking algorithm may be used to calculate the head motion tracking data of the user based on the motion data of the headphone, and may further calculate relative motion data between the electronic device and a head of the user based on the motion data of the electronic device and the head motion tracking data of the user. The sound effect algorithm is used to perform sound effect rendering on the audio data.

The headphone may support communication with the electronic device through the agreed command. After the electronic device is paired with or reconnected to the headphone, if the headphone-targeted compensation of the headphone is in the enabling state, the electronic device may communicate with the headphone through the agreed command, to obtain the headphone sound effect compensation parameter of the headphone, and may store the headphone sound effect compensation parameter. If the head motion tracking of the headphone is in the enabling state, the electronic device may receive, through the agreed command, the motion data of the headphone or the head motion tracking data of the user sent by the headphone through the data sending module, and may store the motion data of the headphone or the head motion tracking data of the user.

When the electronic device detects an operation of triggering playing audio by the user, in response to the operation, the electronic device obtains the head motion tracking data of the user, obtains the motion data of the electronic device through the motion tracking sensor, inputs the head motion tracking data of the user and the motion data of the electronic device to the motion tracking algorithm, to obtain the relative motion data between the electronic device and the head of the user, then inputs the relative motion data between the electronic device and the head of the user, the headphone sound effect compensation parameter obtained from the headphone, and an original sound effect compensation parameter of the electronic device to the sound effect algorithm to render the audio data, to obtain audio data after sound effect rendering, and finally sends the audio data after the sound effect rendering to the headphone. The headphone receives, through the data receiving module, the audio data after the sound effect rendering, and plays audio corresponding to the audio data after the sound effect rendering.

In the method, that the electronic device obtains the head motion tracking data of the user includes two possible implementations.

In a possible implementation, the electronic device calculates the head motion tracking data of the user based on the motion data of the headphone.

If the head motion tracking of the headphone is in the enabling state, the headphone may obtain the motion data, namely, the acceleration and the angular velocity, of the headphone through the IMU sensor, obtain the acceleration and the angular velocity of the headphone from the IMU sensor through the IMU driver, and then transmit the acceleration and the angular velocity of the headphone to the electronic device through the data sending module of the Bluetooth module. The electronic device may input the acceleration and the angular velocity of the headphone to the motion tracking algorithm, where an output of the motion tracking algorithm is the head motion tracking data of the user.

In this implementation, the headphone may not include the motion tracking algorithm, and there is no need to calculate the head motion tracking data of the user. This can save a calculation capability of the headphone.

In the other possible implementation, the electronic device receives the head motion tracking data of the user sent by the headphone.

If the head motion tracking of the headphone is in the enabling state, the headphone may obtain the motion data, namely, the acceleration and the angular velocity, of the headphone through the IMU sensor, obtain the acceleration and the angular velocity of the headphone from the IMU sensor through the IMU driver, input the acceleration and the angular velocity of the headphone to the motion tracking algorithm, where an output of the motion tracking algorithm is the head motion tracking data of the user, and finally transmit the head motion tracking data of the user to the electronic device through the data sending module of the Bluetooth module. The electronic device receives the head motion tracking data of the user.

In this implementation, the electronic device does not need to calculate the head motion tracking data of the user. This can save a calculation capability of the electronic device.

Optionally, if the head motion tracking of the headphone is in the disabling state and the headphone-targeted compensation of the headphone is in the enabling state, when the electronic device detects the operation of triggering playing the audio by the user, in response to the operation, the electronic device may input the headphone sound effect compensation parameter obtained from the headphone and the original sound effect compensation parameter of the electronic device into the sound effect algorithm to render the audio data, to obtain audio data after sound effect rendering, and send the audio data after the sound effect rendering to the headphone. The headphone receives, through the data receiving module, the audio data after the sound effect rendering, and plays audio corresponding to the audio data after the sound effect rendering.

If the head motion tracking of the headphone is in the enabling state, the headphone-targeted compensation of the headphone is in the disabling state, and the electronic device stores a universal or default headphone sound effect compensation parameter, when the electronic device detects the operation of triggering playing the audio by the user, in response to the operation, the electronic device obtains the head motion tracking data of the user, obtains the motion data of the electronic device through the motion tracking sensor, then inputs the head motion tracking data of the user and the motion data of the electronic device into the motion tracking algorithm, to obtain the relative motion data between the electronic device and the head of the user, then inputs the relative motion data between the electronic device and the head of the user, the universal or default headphone sound effect compensation parameter, and the original sound effect compensation parameter of the electronic device into the sound effect algorithm to render the audio data, to obtain audio data after sound effect rendering, and finally sends the audio data after the sound effect rendering to the headphone. The headphone receives, through the data receiving module, the audio data after the sound effect rendering, and plays audio corresponding to the audio data after the sound effect rendering.

If the head motion tracking of the headphone is in the disabling state, the headphone-targeted compensation of the headphone is in the enabling state, and the electronic device stores a universal or default headphone sound effect compensation parameter, when the electronic device detects the operation of triggering playing the audio by the user, in response to the operation, the electronic device may input the universal or default headphone sound effect compensation parameter and the original sound effect compensation parameter of the electronic device into the sound effect algorithm to render the audio data, to obtain audio data after sound effect rendering, and send the audio data after the sound effect rendering to the headphone. The headphone receives, through the data receiving module, the audio data after the sound effect rendering, and plays audio corresponding to the audio data after the sound effect rendering.

According to the method provided in this embodiment of this application, the electronic device may use different headphone sound effect compensation methods according to enabling or disabling of the head motion tracking and headphone-targeted compensation functions. This is applicable to different scenarios, and has more flexibility.

In an optional embodiment, in the foregoing method, after the electronic device is paired with or reconnected to the headphone, the electronic device may further communicate with the headphone through the agreed command to obtain a model and/or a serial number of the headphone. The electronic device may determine, based on the model and/or the serial number of the headphone, whether the headphone and the electronic device are from a same manufacturer.

For example, the electronic device stores a database of models of a plurality of headphones. The plurality of headphones and the electronic device are manufactured by a same manufacturer. The electronic device obtains the model of the headphone through the agreed command. If the model is the same as any model included in the database, the electronic device may determine that the headphone and the electronic device are manufactured by the same manufacturer.

In the foregoing method, if the headphone may support communication with the electronic device through the agreed command, after the electronic device is paired with or reconnected to the headphone, the electronic device may communicate with the headphone through the agreed command to obtain the headphone sound effect compensation parameter of the headphone, the model of the headphone, the serial number of the headphone, and the head motion tracking data, and may store the headphone sound effect compensation parameter, the model of the headphone, the serial number of the headphone, and the head motion tracking data.

Embodiments of this application provide two types of methods in which the electronic device communicates with the headphone through the agreed command.

In a possible implementation, FIG. 6 is a schematic flowchart of a communication method 600. The method 600 is applicable to the foregoing scenario shown in FIG. 1. However, this is not limited in this embodiment of this application.

As shown in FIG. 6, the method 600 may include the following steps.

S601: After an electronic device is paired with or reconnected to a headphone, the electronic device sends a query command to the headphone, and correspondingly, the headphone receives the query command.

The electronic device may send the query command based on a Bluetooth common protocol. A format of the query command may be customized by a manufacturer. This is not specifically limited in this embodiment of this application.

For example, the format of the query command may be defined as 0XF0F0F0F0. After the electronic device is paired with or reconnected to the headphone, the electronic device may send the query command based on a serial port configuration (serial port profile, SPP) protocol.

S602: If the headphone may support communication with the electronic device through an agreed command, the headphone sends a response to the electronic device based on the query command, and correspondingly, the electronic device receives the response.

If the headphone may support communication with the electronic device through an agreed command, the headphone may determine a meaning of the query command and send a response to the electronic device based on the query command. A format of the response may also be customized by the manufacturer. This is not specifically limited in this embodiment of this application.

For example, the manufacturer may preset a correspondence between the query command and the response in the headphone. The format of the query command may be defined as 0XF0F0F0F0, and the format of the response may be defined as 0XABABABAB. After receiving the query command 0XF0F0F0F0 of the electronic device, the headphone may determine the response 0XABABABAB based on the preset correspondence, and send the response to the electronic device.

If the headphone does not support communication with the electronic device through an agreed command, the headphone does not determine a meaning of the query command and cannot respond. When the electronic device does not receive a response within a duration, it may be determined that communication with the electronic device through the agreed command is not supported. In this case, if the electronic device detects an operation of playing audio by a user, in response to the operation, the electronic device may perform headphone sound effect compensation on audio data based on a conventional technology, that is, perform headphone sound effect compensation on the audio data by using a universal or default headphone sound effect compensation parameter.

S603: The electronic device sends an information reporting capability query command to the headphone based on the response, and correspondingly, the headphone receives the information reporting capability query command.

The information reporting capability query command is used to query whether the headphone has a capability of reporting information about the headphone. The information about the headphone may include a model of the headphone, a serial number of the headphone, a headphone sound effect compensation parameter, and head tracking data.

S604: The headphone sends an information reporting capability response to the electronic device based on the information reporting capability query command, and correspondingly, the electronic device receives the information reporting capability response.

A data format of the information reporting capability response may be customized by the manufacturer. This is not specifically limited in the embodiment of this application.

For example, the data format of the information reporting capability response may be shown in Table 1.

TABLE 1

| | | Headphone Sound Effect | | | |
|---|---|---|---|---|---|
| | | Compensation Parameter | | | |
| Basic Parameter | | Amplitude- | | | |
| | Serial | frequency | Phase-frequency | Head Tracking Data | |
| Model | number | compensation | compensation | Displacement | Angle |
| 0/1 | 0/1 | 0/1 | 0/1 | (0/1, 0/1, 0/1) | (0/1, 0/1, 0/1) |

As shown in Table 1, in the data format of the information reporting capability response, 1 represents that the headphone has an uploading capability for a corresponding parameter, and 0 represents that the headphone does not have an uploading capability for a corresponding parameter. In the head tracking data, the displacement includes components in three directions: x, y, and z, and the angle includes an angle of rotation about x, y, and z axes.

S605: The electronic device sends an existing-information reporting command to the headphone based on the information reporting capability response, and correspondingly, the headphone receives the existing-information reporting command.

The existing-information reporting command is used to instruct the headphone to report uploadable data. If the headphone has a capability of reporting the model of the headphone, the serial number of the headphone, the amplitude-frequency compensation parameter of the headphone, the phase-frequency compensation parameter of the headphone, and the displacement and the angle in the head tracking data, the existing-information reporting command may be used to instruct the headphone to report the model of the headphone, the serial number of the headphone, the amplitude-frequency compensation parameter of the headphone, the phase-frequency compensation parameter of the headphone, and the displacement and the angle in the head tracking data.

There may be one or more existing-information reporting commands. This is not limited in this embodiment of this application.

If there is one existing-information reporting command, the electronic device may obtain all data that can be reported by the headphone through one existing-information reporting command. This can reduce signaling interaction.

If there are a plurality of existing-information reporting commands, the electronic device may obtain required parameters in real time through the existing-information reporting commands when needed. This is more flexible. In addition, required data does not need to be prestored. This can save internal memory space of the electronic device.

S606: The headphone sends an existing-information reporting response to the electronic device based on the existing-information reporting command, and correspondingly, the electronic device receives the existing-information reporting response.

The headphone may send the existing-information reporting response to the electronic device based on data that needs to be reported and that is indicated by the existing-information reporting command. The existing-information reporting response includes the data that needs to be reported.

For example, the existing-information reporting command is used to instruct the headphone to report the model of the headphone, the serial number of the headphone, the amplitude-frequency compensation parameter of the headphone, and the phase-frequency compensation parameter of the headphone. In this case, the headphone sends the existing-information reporting response to the electronic device based on the existing-information reporting command, where the existing-information reporting response includes the model of the headphone, the serial number of the headphone, the amplitude-frequency compensation parameter of the headphone, and the phase-frequency compensation parameter of the headphone.

It should be noted that if the existing-information reporting command is used to instruct the headphone to report the displacement and the angle in the head tracking data, the headphone may obtain an acceleration and an angular velocity of the headphone in real time or periodically through an IMU sensor, read the acceleration and the angular velocity of the headphone from the IMU sensor in real time or periodically through an IMU driver, then calculate the displacement and the angle based on the acceleration and the angular velocity through a motion tracking algorithm, and finally transmit the displacement and the angle to the electronic device through a data sending module of a Bluetooth module.

It should be additionally noted that if the headphone does not include the motion tracking algorithm, the displacement shown in Table 1 above may be replaced with the acceleration, and the angle may be replaced with the angular velocity.

If the existing-information reporting response includes the model of the headphone and/or the serial number of the headphone, the electronic device may determine, based on the model of the headphone and/or the serial number of the headphone, whether the headphone and the electronic device are manufactured by a same manufacturer.

If the existing-information reporting response includes the amplitude-frequency compensation parameter of the headphone and the phase-frequency compensation parameter of the headphone, when the electronic device detects the operation of playing the audio by the user, the electronic device may input the amplitude-frequency compensation parameter of the headphone and the phase-frequency compensation parameter of the headphone to a sound effect algorithm in response to the operation, to render the audio.

According to the communication method provided in this embodiment of this application, before obtaining the information about the headphone from the headphone, the electronic device first asks, through the agreed command, the capability of the headphone to report information, and indicates, based on the capability of the headphone to report information, the headphone to report information required by the electronic device. This is beneficial to obtaining the information about the headphone within a reporting capability of the headphone and avoiding invalid indication.

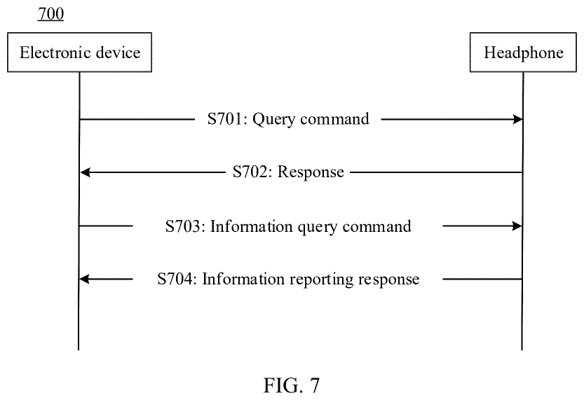

In another possible implementation, FIG. 7 is a schematic flowchart of another communication method 700. The method 700 is applicable to the foregoing scenario shown in FIG. 1. However, this is not limited in this embodiment of this application.

As shown in FIG. 7, the method 700 may include the following steps.

S701: After an electronic device is paired with or reconnected to a headphone, the electronic device sends a query command to the headphone, and correspondingly, the headphone receives the query command.

The electronic device may send the query command based on a Bluetooth common protocol. A format of the query command may be customized by a manufacturer. This is not specifically limited in this embodiment of this application.

For example, the format of the query command may be defined as 0XF0F0F0F0. After the electronic device is paired with or reconnected to the headphone, the electronic device may send the query command based on a serial port configuration (serial port profile, SPP) protocol.

S702: If the headphone can support communication with the electronic device through an agreed command, the headphone sends a response to the electronic device based on the query command, and correspondingly, the electronic device receives the response.

If the headphone may support communication with the electronic device through an agreed command, the headphone may determine a meaning of the query command and send a response to the electronic device based on the query command. A format of the response may also be customized by the manufacturer. This is not specifically limited in this embodiment of this application.

For example, the manufacturer may preset a correspondence between the query command and the response in the headphone. The format of the query command may be defined as 0XF0F0F0F0, and the format of the response may be defined as 0XABABABAB. After receiving the query command 0XF0F0F0F0 of the electronic device, the headphone may determine the response 0XABABABAB based on the preset correspondence, and send the response to the electronic device.

If the headphone may support communication with the electronic device through the agreed command, the headphone does not determine a meaning of the query command and cannot respond. When the electronic device does not receive a response within a duration, it may be determined that communication with the electronic device through the agreed command is not supported. In this case, if the electronic device detects an operation of playing audio by a user, in response to the operation, the electronic device may render a sound effect based on a conventional technology, that is, perform headphone sound effect compensation on audio data by using a universal or default headphone sound effect compensation parameter.

S703: The electronic device sends an information query command to the headphone based on the response, and correspondingly, the headphone receives the information query command.

The information query command is used to instruct the headphone to report data. A format of the information query command may also be customized by the manufacturer. This is not specifically limited in this embodiment of this application.

For example, the format of the information query command may be customized to 0XCDCDCDCD.

S704: The headphone sends an information reporting response to the electronic device based on the information query command, and correspondingly, the electronic device receives the information reporting response.

A data format of the information reporting response may be customized by the manufacturer. This is not specifically limited in this embodiment of this application.

For example, the data format of the information reporting response may be shown in Table 2.

TABLE 2

| | | Headphone Sound Effect | | | |
|---|---|---|---|---|---|
| | | Compensation Parameter | | | |
| Basic Parameter | | Amplitude- | Phase- | | |
| | Serial | frequency | frequency | Head Tracking Data | |
| Model | number | compensation | compensation | Displacement | Angle |
| XX . . . X/NA | XX . . . X/NA | XX . . . X/NA | XX . . . X/NA | (x/NA, y/NA, | (x/NA, y/NA, |
| | | | | z/NA) | z/NA) |

As shown in Table 2, in the data format of the information reporting response, XX . . . X indicates that the headphone has a corresponding parameter, and NA indicates that the headphone does not have a corresponding parameter. In the head tracking data, the displacement includes components in three directions: x, y, and z, the angle includes an angle of rotation about x, y, and z axes, and NA indicates that the headphone does not have a corresponding dimensional parameter.

The electronic device may analyze defined data after receiving the information reporting response. If an analysis result is NA, it is determined that the corresponding parameter is not received. The corresponding parameter may be obtained if an analysis result is not NA.

If the information reporting response includes the model of the headphone and/or the serial number of the headphone, the electronic device may determine, based on the model of the headphone and/or the serial number of the headphone, whether the headphone and the electronic device are manufactured by a same manufacturer.

If the information reporting response includes the amplitude-frequency compensation parameter of the headphone and the phase-frequency compensation parameter of the headphone, when the electronic device detects the operation of playing the audio by the user, the electronic device may input the amplitude-frequency compensation parameter of the headphone and the phase-frequency compensation parameter of the headphone to a sound effect algorithm in response to the operation, to render the audio.

According to the communication method provided in this embodiment of this application, the headphone may send, to the electronic device through one information reporting response, data that can be reported, and indicate which data cannot be reported. The electronic device does not need to query in advance for a reporting capability of which data the headphone has. This is beneficial to saving signaling interaction and improving data obtaining efficiency.

In an optional embodiment, enabling or disabling of headphone-targeted compensation and head motion tracking of the foregoing headphone is default or determined in response to an enabling or disabling operation of the user.

An application program for controlling a function of the headphone may be installed on the electronic device. The application program may support headphone-targeted compensation and head motion tracking functions, and provide a control to support enabling or disabling performed by the user. There is a default state for the headphone-targeted compensation and head motion tracking functions when the application program for controlling the function of the headphone is installed on the electronic device. The default state may be an enabling state or a disabling state. This is not limited in this embodiment of this application. The user may change the enabling or disabling state of the headphone-targeted compensation and the head motion tracking on the electronic device based on a need of the user. When detecting that the user changes the state of the headphone-targeted compensation and/or the head motion tracking, the electronic device changes the enabling or disabling state of the headphone-targeted compensation and/or changes the enabling or disabling state of the head motion tracking.

When the application program for controlling the function of the headphone is installed on the electronic device, if default states of the headphone-targeted compensation and the head motion tracking are both the enabling state, the electronic device may detect that the headphone-targeted compensation and the head motion tracking are both in the enabling state. If detecting an operation of disabling the headphone-targeted compensation by the user, the electronic device may change the enabling state of the headphone-targeted compensation to the disabling state in response to the operation. If detecting an operation of disabling the head motion tracking by the user, the electronic device may change the enabling state of the headphone head motion tracking to the disabling state in response to the operation. If detecting an operation of disabling the head motion tracking by the user, and detecting an operation of disabling the headphone-targeted compensation by the user, in response to the two operations, the electronic device may change the enabling state of the headphone head motion tracking to the disabling state, and change the enabling state of the headphone-targeted compensation to the disabling state.

It may be understood that if the headphone-targeted compensation and the head motion tracking are both in the enabling state, controls corresponding to the headphone-targeted compensation and the head motion tracking are both in an on state. If the headphone-targeted compensation is in the disabling state and the head motion tracking is in the enabling state, a control corresponding to the headphone-targeted compensation is in an off state, and a control corresponding to the head motion tracking is in an on state. If the headphone-targeted compensation is in the enabling state and the head motion tracking is in the disabling state, a control corresponding to the headphone-targeted compensation is in an on state, and a control corresponding to the head motion tracking is in an off state. If the headphone-targeted compensation and the head motion tracking are both in the disabling state, controls corresponding to the headphone-targeted compensation and the head motion tracking are both in an on state.

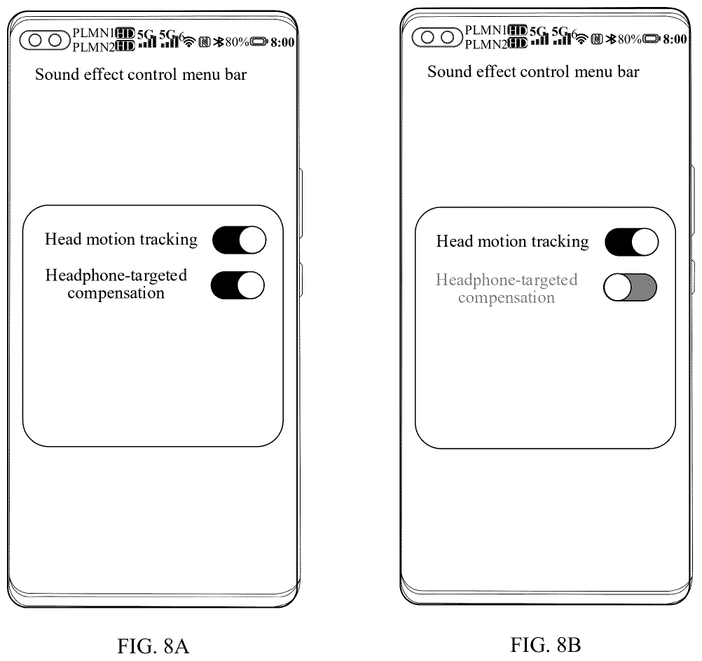

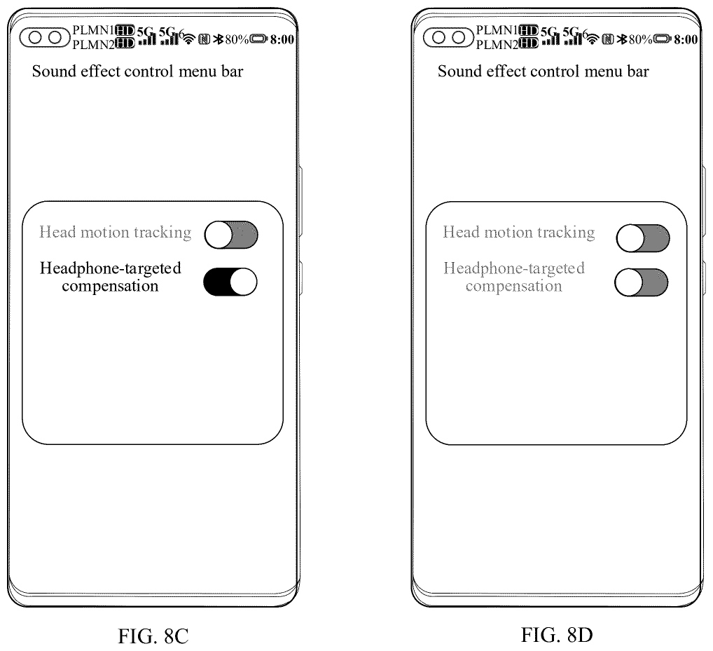

For example, FIG. 8A, FIG. 8B, FIG. 8C, and FIG. 8D are a diagram of a function interface. As shown in FIG. 8A, FIG. 8B, FIG. 8C, and FIG. 8D, an electronic device may be a mobile phone. An application program for controlling a function of a headphone is installed on the mobile phone. The application program provides a sound effect control menu bar interface. The interface includes head motion tracking and a corresponding control thereof, and headphone-targeted compensation and a corresponding control thereof. As shown in FIG. 8A, the controls corresponding to the head motion tracking and the headphone-targeted compensation are both in an on state. As shown in FIG. 8B, the control corresponding to the head motion tracking is in an on state, the control corresponding to the headphone-targeted compensation is in an off state, and a typeface of the headphone-targeted compensation and the corresponding control thereof are both displayed in grayscale, indicating unavailability. As shown in FIG. 8C, the control corresponding to the headphone-targeted compensation is in an on state, the control corresponding to the head motion tracking is in an off state, and a typeface of the head motion tracking and the corresponding control thereof are both displayed in grayscale, indicating unavailability. As shown in FIG. 8D, the control corresponding to the headphone-targeted compensation and the control corresponding to the head motion tracking are both in an off state, and a typeface of the headphone-targeted compensation and the corresponding control thereof, and a typeface of the head motion tracking and the corresponding control thereof are all displayed in grayscale, indicating unavailability.

The headphone may send a headphone sound effect compensation parameter to the electronic device if the control corresponding to the headphone-targeted compensation is in the on state. The headphone may not send a headphone sound effect compensation parameter to the electronic device if the control corresponding to the headphone-targeted compensation is in the off state. The headphone may send head motion tracking data to the electronic device if the control corresponding to the head motion tracking is in the on state. The headphone may not send the head motion tracking data to the electronic device if the control corresponding to the head motion tracking is in the off state.

After being paired with or reconnected to the headphone, the electronic device may detect a state of the control corresponding to the headphone-targeted compensation, to determine whether to send the headphone sound effect compensation parameter to the electronic device; or may detect a state of the control corresponding to the head motion tracking, to determine whether to send the head motion tracking data to the electronic device. When the electronic device is in a connected state with the headphone, the electronic device may detect whether the state of the control corresponding to the headphone-targeted compensation is changed, or may detect whether the state of the control corresponding to the head motion tracking is changed.

If the electronic device detects that the state of the control corresponding to the headphone-targeted compensation is changed from the on state to the off state, the electronic device may send information for indicating that a headphone-targeted compensation function is disabled to the headphone, and the headphone receives the information, and may store the information in a headphone function control module. In the method 600, the reported data that is indicated by an existing-information capability and that is sent by the electronic device to the headphone may not include the headphone sound effect compensation parameter. In the method 700, the headphone may change the amplitude-frequency compensation parameter and the amplitude-frequency compensation parameter in Table 2 to NA based on the information.

If the electronic device detects that the state of the control corresponding to the head motion tracking is changed from the on state to the off state, the electronic device may send information for indicating that a head motion tracking function of the headphone is disabled to the headphone, and the headphone receives the information, and may store the information in a headphone function control module. In the method 600, the reported data that is indicated by an existing-information capability and that is sent by the electronic device to the headphone may not include the head motion tracking data. In the method 700, the headphone may change the displacement and the angle in Table 2 to NA based on the information.

According to the method provided in this embodiment of this application, the enabling or disabling of the headphone-targeted compensation and the head motion tracking of the headphone is default or determined in response to an enabling or disabling operation of the user. This has greater flexibility and a wider use range.

### Embodiment 2

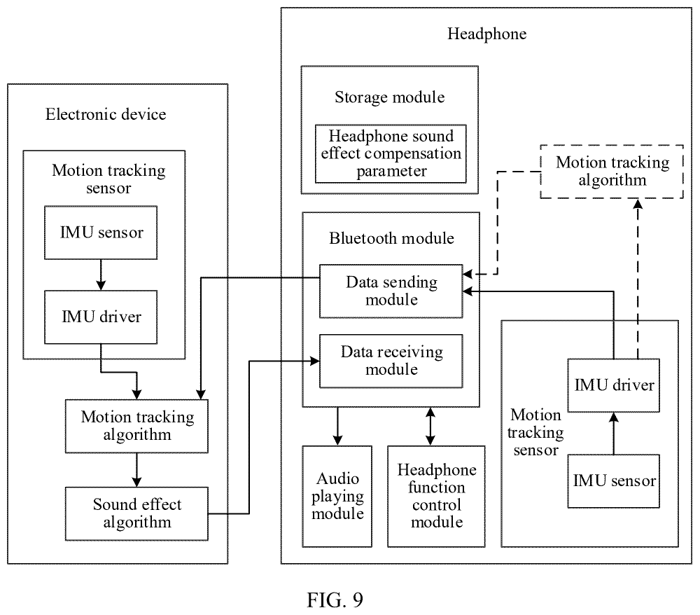

FIG. 9 is a block diagram of a headphone sound effect compensation method according to an embodiment of this application. As shown in FIG. 9, an electronic device is in a connected state with a headphone. The headphone may be a left headphone of a pair of headphones or a right headphone of the pair of headphones. This is not limited in this embodiment of this application. The headphone does not support communication with the electronic device through an agreed command, but may communicate with the electronic device through a universal command. The electronic device has a sound effect rendering capability and a sound effect compensation capability.

Modules and functions included in the headphone and the electronic device are the same as those in FIG. 5. Details are not described herein again. It should be noted that a headphone sound effect compensation parameter stored in a storage module in the headphone may not support being transmitted to the electronic device through the universal command. In other words, the electronic device may perform headphone sound effect compensation based on a universal headphone sound effect compensation parameter stored in the electronic device, but cannot perform headphone sound effect compensation based on the headphone sound effect compensation parameter stored in the headphone. The headphone supports headphone-targeted compensation and head motion tracking, but enabling or disabling of the head motion tracking does not support being selected by a user, and the head motion tracking is often enabled. It should be noted that, that the head motion tracking is often enabled is only an example, and enabling or disabling of the head motion tracking may alternatively support being selected by a user.

When the electronic device detects an operation of triggering playing audio by the user, in response to the operation, the electronic device obtains head motion tracking data of the user, obtains motion data of the electronic device through a motion tracking sensor, inputs the head motion tracking data of the user and the motion data of the electronic device to a motion tracking algorithm, to obtain relative motion data between the electronic device and a head of the user, then inputs the relative motion data between the electronic device and the head of the user, the universal headphone sound effect compensation parameter stored in the inside of the electronic device, and an original sound effect compensation parameter of the electronic device to a sound effect algorithm to render audio data, to obtain audio data after sound effect rendering, and finally sends the audio data after the sound effect rendering to the headphone. If the headphone-targeted compensation of the headphone is in an enabling state, the headphone receives, through a data receiving module, the audio data after the sound effect rendering, may perform, based on the headphone sound effect compensation parameter stored in the headphone, headphone sound effect compensation on the audio data after the sound effect rendering, and play audio corresponding to the audio data after the headphone sound effect compensation. If the headphone-targeted compensation of the headphone is in a disabling state, the headphone receives, through a data receiving module, the audio data after the sound effect rendering, and may play audio corresponding to the audio data after the sound effect compensation of the headphone.

In the foregoing method, that the electronic device obtains the head motion tracking data of the user includes two possible implementations. Specific implementations are the same as those in Embodiment 1 described above. Details are not described herein again.

Optionally, the electronic device may obtain a model and/or a serial number of the headphone through a universal command. The electronic device may determine, based on the model and/or the serial number of the headphone, whether the headphone and the electronic device are from a same manufacturer.

For example, the electronic device stores a database of models of a plurality of headphones. The plurality of headphones and the electronic device are manufactured by a same manufacturer. The electronic device obtains the model of the headphone through the universal command. If the model is the same as any model included in the database, the electronic device may determine that the headphone and the electronic device are manufactured by the same manufacturer.

In an optional embodiment, the enabling or disabling of the headphone-targeted compensation of the headphone is default or determined in response to an enabling or disabling operation of the user.

An application program for controlling a function of the headphone may be installed on the electronic device. The application program may support a headphone-targeted compensation function and provide a control to support enabling or disabling performed by the user. There is a default state for the headphone-targeted compensation function when the application program for controlling the function of the headphone is installed on the electronic device. The default state may be an enabling state or a disabling state. This is not limited in this embodiment of this application. The user may change the enabling or disabling state of the headphone-targeted compensation on the electronic device based on a need of the user. When detecting that the user changes the state of the headphone-targeted compensation, the electronic device changes the enabling or disabling state of the headphone-targeted compensation.

When the application program for controlling the function of the headphone is installed on the electronic device, if a default state of the headphone-targeted compensation is the enabling state, the electronic device may detect that the headphone-targeted compensation is in the enabling state. If detecting an operation of disabling the headphone-targeted compensation by the user, the electronic device changes the enabling state of the headphone-targeted compensation to the disabling state in response to the operation.

It may be understood that a control corresponding to the headphone-targeted compensation is in an on state if the headphone-targeted compensation is in the enabling state. A control corresponding to the headphone-targeted compensation is in an on state if the headphone-targeted compensation is in the disabling state.

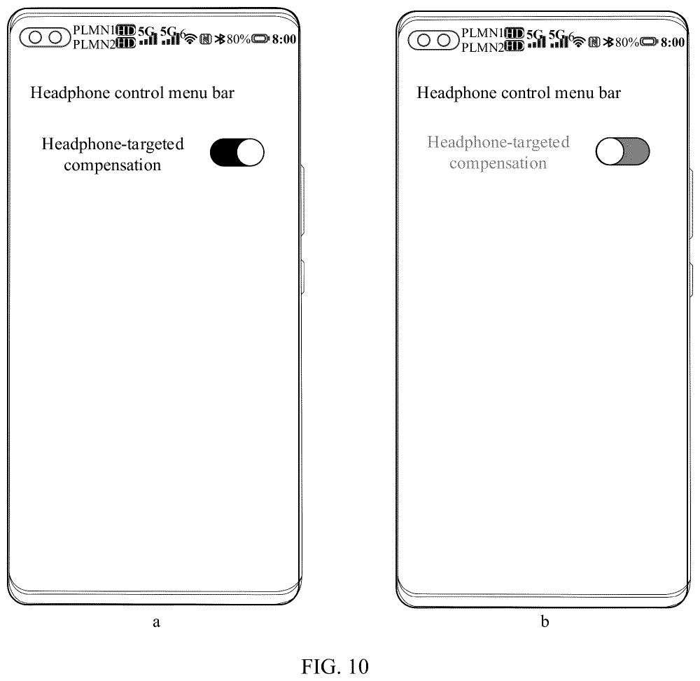

For example, FIG. 10 is a diagram of a function interface. As shown in FIG. 10, an electronic device may be a mobile phone. An application program for controlling a function of a headphone is installed on the mobile phone. The application program provides a headphone control menu bar interface. The interface includes headphone-targeted compensation and a corresponding control thereof. As shown in a in FIG. 10, the control corresponding to the headphone-targeted compensation is in an on state. As shown in b in FIG. 10, the control corresponding to the headphone-targeted compensation is in an off state, and a typeface of the headphone-targeted compensation and the corresponding control thereof are both displayed in grayscale, indicating unavailability.

The headphone may send a headphone sound effect compensation parameter to the electronic device if the control corresponding to the headphone-targeted compensation is in the on state. The headphone may not send a headphone sound effect compensation parameter to the electronic device if the control corresponding to the headphone-targeted compensation is in the off state.

After being paired with or reconnected to the headphone, the electronic device may detect a state of the control corresponding to the headphone-targeted compensation, to determine whether to send the headphone sound effect compensation parameter to the electronic device. When the electronic device is in a connected state with the headphone, the electronic device may detect whether the state of state control corresponding to state headphone-targeted compensation is changed.

If the electronic device detects that the state of the control corresponding to the headphone-targeted compensation is changed from the on state to the off state, the electronic device may send information for indicating that a headphone-targeted compensation function is disabled to the headphone, and the headphone receives the information, and may store the information in a headphone function control module.

### Embodiment 3

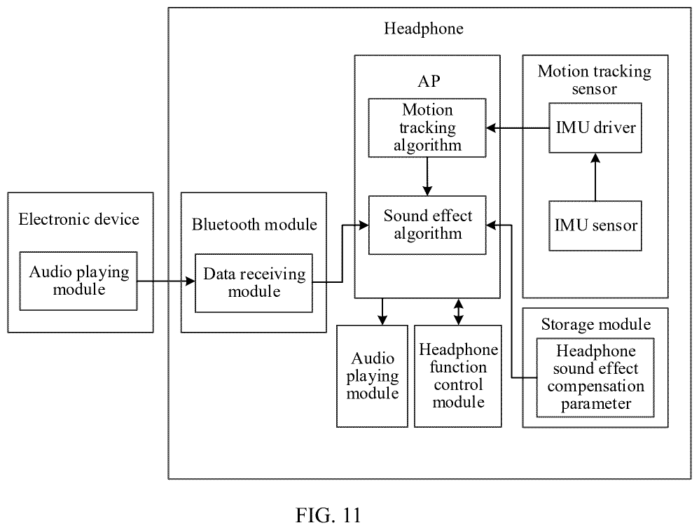

FIG. 11 is a block diagram of a headphone sound effect compensation method according to an embodiment of this application. As shown in FIG. 11, an electronic device is in a connected state with a headphone. The headphone may be a left headphone of a pair of headphones or a right headphone of the pair of headphones. This is not limited in this embodiment of this application. The electronic device does not have a sound effect rendering capability and does not have a sound effect compensation capability. The headphone has a sound effect rendering capability and a sound effect compensation capability.

The headphone may include a storage module, a motion tracking sensor, an application chip (application processor, AP), a Bluetooth module, an audio playing module, and a headphone function control module. The storage module stores a headphone sound effect compensation parameter, where the headphone sound effect compensation parameter may be obtained based on the method shown in FIG. 4. The motion tracking sensor includes an inertial measurement unit (inertial measurement unit, IMU) sensor and an IMU driver, to obtain motion data of the headphone (for example, an acceleration and an angular velocity of the headphone), to calculate head motion tracking data of a user (for example, a displacement and an angle of a head motion of the user). The AP includes a motion tracking algorithm and a sound effect algorithm. The motion tracking algorithm is used to calculate the head motion tracking data of the user based on the motion data of the headphone, and the sound effect algorithm is used to perform sound effect rendering on audio data. The Bluetooth module is configured to perform Bluetooth communication with the electronic device. The Bluetooth module includes a data receiving module. The data receiving module is configured to receive the audio data (or referred to as an audio stream) from the electronic device through a Bluetooth technology. The audio playing module is configured to play audio corresponding to the audio data. The headphone function control module is configured to store states of functions supported by the headphone. For example, a sound effect function of the headphone supports headphone-targeted compensation and head motion tracking. The headphone function control module includes an enabling or disabling state of the headphone-targeted compensation and an enabling or disabling state of the head motion tracking.

The electronic device includes an audio playing module. The audio playing module is configured to play audio or send audio data to the headphone.

The electronic device is in a connected state with the headphone. When the electronic device detects an operation of triggering playing audio by the user, the electronic device may send, in response to the operation, audio data played by the user to the headphone. The headphone may receive, through the data receiving module in the Bluetooth module, the audio data played by the user. If the head motion tracking of the headphone is in the enabling state and the headphone-targeted compensation of the headphone is in the enabling state, the headphone may obtain the motion data, namely, the acceleration and the angular velocity, of the headphone through the IMU sensor, obtain the acceleration and the angular velocity of the headphone from the IMU sensor through the IMU driver, and then input the acceleration and the angular velocity of the headphone to the motion tracking algorithm, where an output of the motion tracking algorithm is the head motion tracking data of the user, and finally may input the head motion tracking data of the user, the headphone sound effect compensation parameter, and an original sound effect compensation parameter of the headphone to the sound effect algorithm to render the audio data played by the user, to obtain audio data after sound effect rendering, and play, through the audio playing module, audio corresponding to the audio data after the sound effect rendering.

Optionally, the electronic device is in a connected state with the headphone. When the electronic device detects an operation of triggering playing audio by the user, the electronic device may send, in response to the operation, audio data played by the user to the headphone. If the head motion tracking of the headphone is in the disabling state and the headphone-targeted compensation of the headphone is in the enabling state, the headphone may input the headphone sound effect compensation parameter and an original sound effect compensation parameter of the headphone into the sound effect algorithm to render the audio data played by the user, to obtain audio data after sound effect rendering, and play, through the audio playing module, audio corresponding to the audio data after the sound effect rendering.

Optionally, the electronic device is in a connected state with the headphone. When the electronic device detects an operation of triggering playing audio by the user, the electronic device may send, in response to the operation, audio data played by the user to the headphone. If the head motion tracking of the headphone is in the enabling state and the headphone-targeted compensation of the headphone is in the disabling state, the headphone may obtain the motion data, namely, the acceleration and the angular velocity, of the headphone through the IMU sensor, obtain the acceleration and the angular velocity of the headphone from the IMU sensor through the IMU driver, and then input the acceleration and the angular velocity of the headphone to the motion tracking algorithm, where an output of the motion tracking algorithm is the head motion tracking data of the user, and finally may input the head motion tracking data of the user and an original sound effect compensation parameter of the headphone to the sound effect algorithm to render the audio data played by the user, to obtain audio data after sound effect rendering, and play, through the audio playing module, audio corresponding to the audio data after the sound effect rendering.

Optionally, the electronic device is in a connected state with the headphone. When the electronic device detects an operation of triggering playing audio by the user, the electronic device may send, in response to the operation, audio data played by the user to the headphone. If the head motion tracking of the headphone is in the disabling state and the headphone-targeted compensation of the headphone is in the disabling state, the headphone inputs an original sound effect compensation parameter of the headphone to the sound effect algorithm to render the audio data played by the user, to obtain audio data after sound effect rendering, and play, through the audio playing module, audio corresponding to the audio data after the sound effect rendering.

In an optional embodiment, enabling or disabling of headphone-targeted compensation and head motion tracking of the foregoing headphone is default or determined in response to an enabling or disabling operation of the user.

An application program for controlling a function of the headphone may be installed on the electronic device. The application program may support headphone-targeted compensation and head motion tracking functions, and provide a control to support enabling or disabling performed by the user. There is a default state for the headphone-targeted compensation and head motion tracking functions when the application program for controlling the function of the headphone is installed on the electronic device. The default state may be an enabling state or a disabling state. This is not limited in this embodiment of this application. The user may change the enabling or disabling state of the headphone-targeted compensation and the head motion tracking on the electronic device based on a need of the user. When detecting that the user changes the state of the headphone-targeted compensation and/or the head motion tracking, the electronic device changes the enabling or disabling state of the headphone-targeted compensation and/or changes the enabling or disabling state of the head motion tracking.

When the application program for controlling the function of the headphone is installed on the electronic device, if default states of the headphone-targeted compensation and the head motion tracking are both the enabling state, the electronic device may detect that the headphone-targeted compensation and the head motion tracking are both in the enabling state. If detecting an operation of disabling the headphone-targeted compensation by the user, the electronic device changes the enabling state of the headphone-targeted compensation to the disabling state in response to the operation. If detecting an operation of disabling the head motion tracking by the user, the electronic device changes the enabling state of the headphone head motion tracking to the disabling state in response to the operation. If detecting an operation of disabling the head motion tracking by the user, and detecting an operation of disabling the headphone-targeted compensation by the user, in response to the two operations, the electronic device changes the enabling state of the headphone head motion tracking to the disabling state, and changes the enabling state of the headphone-targeted compensation to the disabling state.

It may be understood that if the headphone-targeted compensation and the head motion tracking are both in the enabling state, controls corresponding to the headphone-targeted compensation and the head motion tracking are both in an on state. If the headphone-targeted compensation is in the disabling state and the head motion tracking is in the enabling state, a control corresponding to the headphone-targeted compensation is in an off state, and a control corresponding to the head motion tracking is in an on state. If the headphone-targeted compensation is in the enabling state and the head motion tracking is in the disabling state, a control corresponding to the headphone-targeted compensation is in an on state, and a control corresponding to the head motion tracking is in an off state. If the headphone-targeted compensation and the head motion tracking are both in the disabling state, controls corresponding to the headphone-targeted compensation and the head motion tracking are both in an on state.

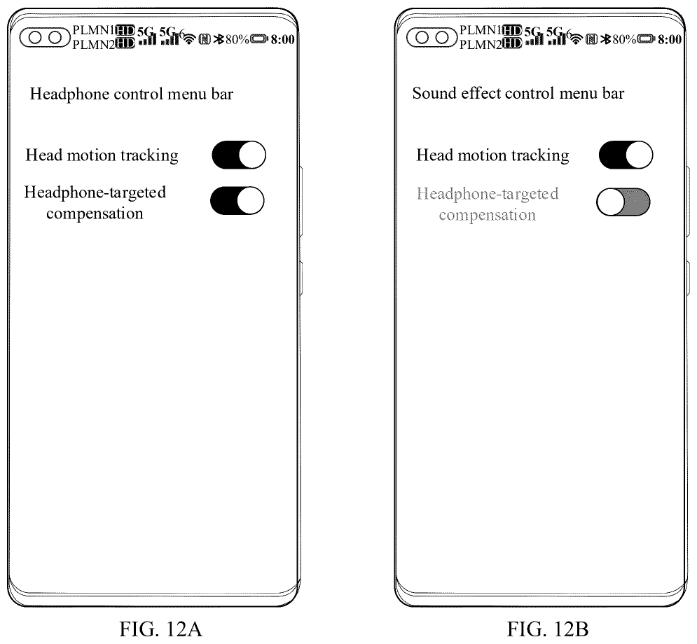

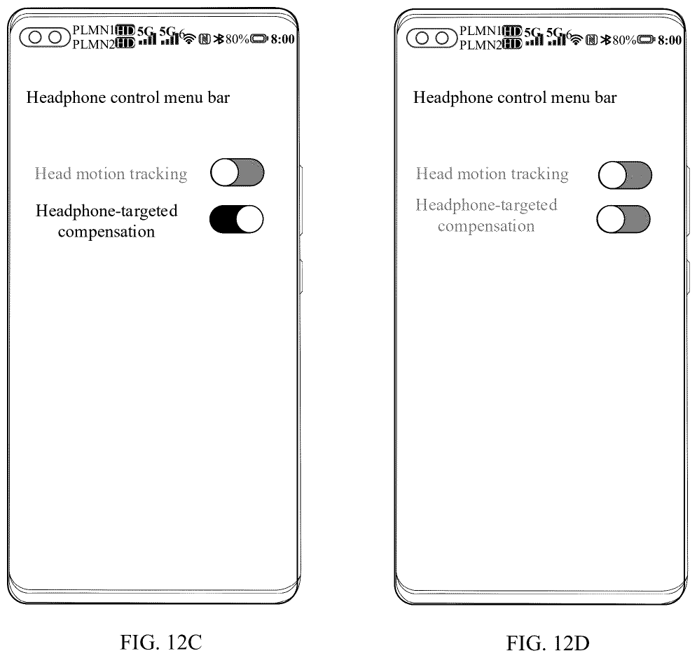

For example, FIG. 12A, FIG. 12B, FIG. 12C, and FIG. 12D are a diagram of a function interface. As shown in FIG. 12A, FIG. 12B, FIG. 12C, and FIG. 12D, an electronic device may be a mobile phone. An application program for controlling a function of a headphone is installed on the mobile phone. The application program provides a headphone control menu bar interface. The interface includes head motion tracking and a corresponding control thereof, and headphone-targeted compensation and a corresponding control thereof. As shown in FIG. 12A, the controls corresponding to the head motion tracking and the headphone-targeted compensation are both in an on state. As shown in FIG. 12B, the control corresponding to the head motion tracking is in an on state, the control corresponding to the headphone-targeted compensation is in an off state, and a typeface of the headphone-targeted compensation and the corresponding control thereof are both displayed in grayscale, indicating unavailability. As shown in FIG. 12C, the control corresponding to the headphone-targeted compensation is in an on state, the control corresponding to the head motion tracking is in an off state, and a typeface of the head motion tracking and the corresponding control thereof are both displayed in grayscale, indicating unavailability. As shown in FIG. 12D, the control corresponding to the headphone-targeted compensation and the control corresponding to the head motion tracking are both in an off state, and a typeface of the headphone-targeted compensation and the corresponding control thereof, and a typeface of the head motion tracking and the corresponding control thereof are all displayed in grayscale, indicating unavailability.

The headphone may perform headphone sound effect compensation on audio data based on a headphone sound effect compensation parameter if the control corresponding to the headphone-targeted compensation is in an on state. The headphone may perform sound effect compensation on audio data based on head motion tracking data if the control corresponding to the head motion tracking is in an on state.

After receiving the audio data sent by the electronic device, the headphone may detect a state of the control corresponding to the headphone-targeted compensation, to determine whether to perform headphone sound effect compensation on the audio data based on the headphone sound effect compensation parameter; or may detect a state of the control corresponding to the head motion tracking, to determine whether to perform sound effect rendering on the audio data based on the head motion tracking data. When the electronic device is in a connected state with the headphone, the electronic device may further detect whether the state of the control corresponding to the headphone-targeted compensation is changed, or may detect whether the state of the control corresponding to the head motion tracking is changed.

If the electronic device detects that the state of the control corresponding to the headphone-targeted compensation is changed from the on state to the off state, the electronic device may send information for indicating that a headphone-targeted compensation function is disabled to the headphone, and the headphone receives the information, and may store the information in a headphone function control module. If the electronic device detects that the state of the control corresponding to the head motion tracking is changed from the on state to the off state, the electronic device may send information for indicating that a head motion tracking function of the headphone is disabled to the headphone, and the headphone receives the information, and may store the information in a headphone function control module.

It should be noted that in the foregoing three headphone sound effect compensation methods provided in embodiments of this application, the headphones may be a same headphone, that is, the headphones may all store the headphone sound effect compensation parameter and have the sound effect compensation function.

Embodiments of this application provide the foregoing three headphone sound effect compensation methods. Embodiments of this application further provide a headphone sound effect compensation solution selection method, used to select an appropriate headphone sound effect compensation method from the three headphone sound effect compensation methods to perform sound effect compensation on audio data.

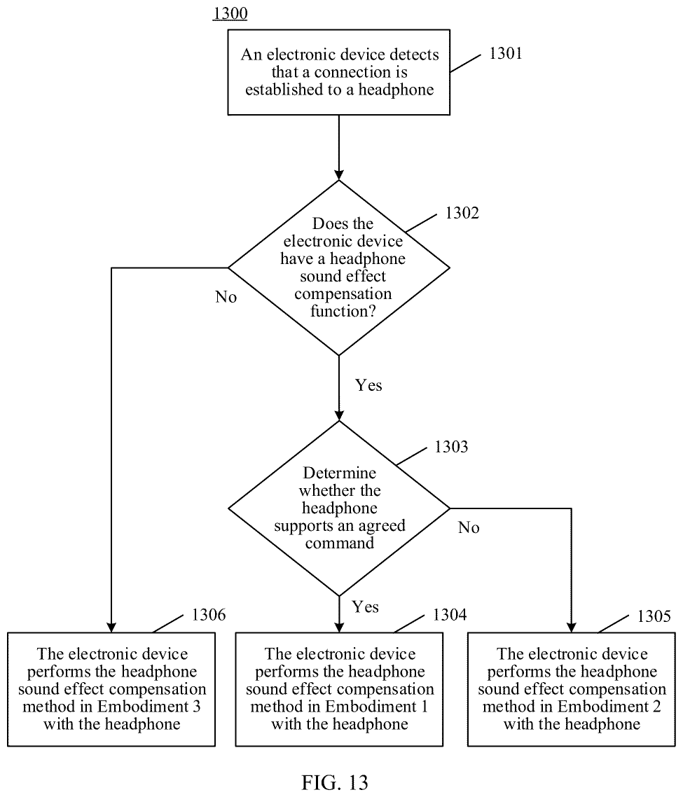

For example, FIG. 13 is a schematic flowchart of a headphone sound effect compensation solution selection method 1300. The method 1300 may include the following steps.

S1301: An electronic device detects that a connection is established to a headphone.

After the electronic device is paired with or reconnected to the headphone, the electronic device may detect that the electronic device establishes the connection to the headphone. The headphone may store a headphone sound effect compensation parameter or may not store a headphone sound effect compensation parameter. This is not limited in this embodiment of this application.

S1302: The electronic device determines whether the electronic device has a headphone sound effect compensation function.

If the electronic device has the headphone sound effect compensation function, the electronic device may include a universal headphone sound effect compensation parameter to perform headphone sound effect compensation on audio data, or perform headphone sound effect compensation on audio data based on the headphone sound effect compensation parameter stored in the headphone. The electronic device may determine whether the electronic device has the headphone sound effect compensation function by determining whether the electronic device stores the universal headphone sound effect compensation parameter or whether the electronic device stores a sound effect algorithm.

If the electronic device has the headphone sound effect compensation function, the electronic device may determine, through an instruction, whether the headphone stores the headphone sound effect compensation parameter, that is, the electronic device may perform S1303. If the electronic device does not have the headphone sound effect compensation function, the electronic device may determine whether the headphone has the headphone sound effect compensation function. If the headphone has the headphone sound effect compensation function, the electronic device may perform, with the headphone, the headphone sound effect compensation method in Embodiment 3 described above, that is, the electronic device may perform S1306. The electronic device may determine, through an instruction, whether the headphone has the headphone sound effect compensation function.

The headphone may alternatively determine, based on an instruction, whether the electronic device has the headphone sound effect compensation function. If the headphone determines, based on the instruction, that the electronic device has the headphone sound effect compensation function, the headphone may not perform headphone sound effect compensation on audio data sent by the electronic device. If the headphone determines, based on the instruction, that the electronic device does not have the headphone sound effect compensation function, the headphone may perform headphone sound effect compensation on audio data sent by the electronic device.

S1303: If the electronic device has the headphone sound effect compensation function, the electronic device determines whether the headphone supports an agreed command.

For example, in the foregoing example shown in FIG. 6, the electronic device may send the query instruction to the headphone. If the electronic device receives a response that is from the headphone and that is based on the query instruction, the electronic device may determine that the headphone supports the agreed command. If the electronic device does not receive a response that is from the headphone and that is based on the query instruction, the electronic device may determine that the headphone does not support the agreed command.

If the headphone supports the agreed command, the electronic device may communicate with the headphone through the agreed command, that is, the electronic device may perform S1304. If the headphone does not support the agreed command, the electronic device may communicate with the headphone through a universal command, that is, the electronic device may perform S1305.

S1304: If the headphone supports the agreed command, the electronic device may perform, with the headphone, the headphone sound effect compensation method in Embodiment 1 described above.

S1305: If the headphone does not support the agreed command, the electronic device may perform, with the headphone, the headphone sound effect compensation method in Embodiment 2 described above.

S1306: If the electronic device does not have the headphone sound effect compensation function and the headphone has the headphone sound effect compensation function, the electronic device may perform, with the headphone, the headphone sound effect compensation method in Embodiment 3 described above.

If the electronic device does not have the headphone sound effect compensation function and the headphone does not have the headphone sound effect compensation function, neither the electronic device nor the headphone performs headphone sound effect compensation on the audio data.

The sound effect compensation solution selection method provided in this embodiment of this application is beneficial to selecting an appropriate sound effect compensation method to perform sound effect compensation on the audio data in different situations. Flexibility is greater.

Sequence numbers of the processes do not mean execution sequences in the foregoing embodiments. The execution sequences of the processes should be determined based on functions and internal logic of the processes and should not be construed as any limitation on the implementation processes of embodiments of this application.

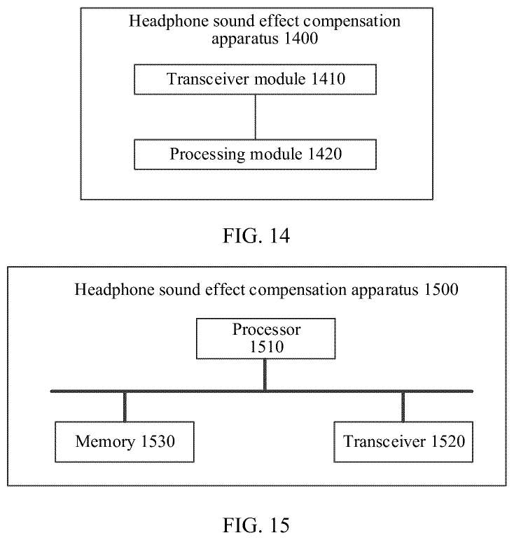

The method according to embodiments of this application is described in detail by combining FIG. 1 to FIG. 13 above. An apparatus according to embodiments of this application is described in detail by combining FIG. 14 and FIG. 15 below.

FIG. 14 is a block diagram of a headphone sound effect compensation apparatus 1400 according to an embodiment of this application. As shown in FIG. 14, the headphone sound effect compensation apparatus 1400 includes: a transceiver module 1410 and a processing module 1420.

In a possible implementation, the headphone sound effect compensation apparatus 1400 is configured to perform the foregoing method performed by the headphone.

The transceiver module 1410 is configured to: send a headphone sound effect compensation parameter to an electronic device if the electronic device has a headphone sound effect compensation function, where the headphone sound effect compensation parameter is used to perform headphone sound effect compensation on audio played by a user.

In another possible implementation, the headphone sound effect compensation apparatus 1400 is configured to perform the foregoing method performed by the electronic device.

The transceiver module 1410 is configured to: receive a headphone sound effect compensation parameter from a headphone if there is a headphone sound effect compensation function. The processing module 1420 is configured to: perform, based on the headphone sound effect compensation parameter in response to an operation of triggering playing audio by a user, headphone sound effect compensation on the audio played by the user.

It should be understood that the headphone sound effect compensation apparatus 1400 herein is embodied in a form of a functional module. The term “module” herein may refer to an application-specific integrated circuit (application-specific integrated circuit, ASIC), an electronic circuit, a processor configured to execute one or more software or firmware programs (for example, a shared processor, a dedicated processor, or a group processor), a storage device, a combined logic circuit, and/or any other suitable component that supports the described function. In an optional example, a person skilled in the art may understand that, the headphone sound effect compensation apparatus 1400 may be specifically the headphone or the electronic device in the foregoing method embodiments, or functions of the headphone or the electronic device in the foregoing method embodiments may be integrated into the headphone sound effect compensation apparatus 1400. The headphone sound effect compensation apparatus 1400 may be configured to perform various procedures and/or steps corresponding to the headphone or the electronic device in the foregoing method embodiments. To avoid repetition, details are not described herein again.

The headphone sound effect compensation apparatus 1400 has functions of implementing corresponding steps performed by the headphone or the electronic device in the foregoing method embodiments. The function may be implemented by hardware, or may be implemented by hardware executing corresponding software. The hardware or software includes one or more modules corresponding to the foregoing function.

In this embodiment of this application, the headphone sound effect compensation apparatus 1400 in FIG. 14 may alternatively be a chip or a chip system, for example, a system on chip (system on chip, SoC).

FIG. 15 is a block diagram of another headphone sound effect compensation apparatus 1500 according to an embodiment of this application. As shown in FIG. 15, the headphone sound effect compensation apparatus 1500 includes: a processor 1510, a transceiver 1520, and a memory 1530. The processor 1510, the transceiver 1520, and the memory 1530 communicate with each other through an internal connection path. The memory 1530 is configured to store instructions. The processor 1510 is configured to execute the instructions stored in the memory 1530, to control the transceiver 1520 to send a signal and/or receive a signal.

It should be understood that, the headphone sound effect compensation apparatus 1500 may be specifically the headphone or the electronic device in the foregoing method embodiments, or functions of the headphone or the electronic device in the foregoing method embodiments may be integrated into the headphone sound effect compensation apparatus 1500, and the headphone sound effect compensation apparatus 1500 may be configured to perform various steps and/or procedures corresponding to the headphone or the electronic device in the foregoing method embodiments. Optionally, the memory 1530 may include a read-only memory and a random access memory, and provide instructions and data to the processor 1510. A part of the memory 1530 may further include a non-volatile random access memory. For example, the memory 1530 may further store information about a device type. The processor 1510 may be configured to execute the instructions stored in the memory 1530. In addition, when the processor 1510 executes the instructions, the processor 1510 may perform the steps and/or procedures corresponding to the headphone or the electronic device in the foregoing method embodiments.

It should be understood that, in this embodiment of this application, the processor 1510 may be a central processing unit (central processing unit, CPU), and the processor may alternatively be a general-purpose processor, a digital signal processor (DSP), an application-specific integrated circuit (ASIC), a field programmable gate array (FPGA) or another programmable logic device, a discrete gate or a transistor logic device, a discrete hardware component, and the like. The general processor may be a microprocessor or the processor may alternatively be any conventional processor.

In an implementation process, the steps of the foregoing method may be accomplished through an integrated logic circuit of hardware or instructions in a form of software in the processor. The steps of the method disclosed with reference to embodiments of this application may be directly accomplished by a hardware processor, or may be accomplished by a combination of hardware and a software module in the processor. The software module may be located in a storage medium that is mature in the art, such as a random access memory, a flash memory, a read-only memory, a programmable read-only memory, an electrically erasable programmable memory, or a register. The storage medium is located in the memory. The processor executes the instructions in the memory, and performs the steps of the foregoing method together with hardware in the processor. To avoid repetition, details are not described herein again.

This application further provides a computer-readable storage medium. The computer-readable storage medium stores a computer program. The computer program is configured to implement the method corresponding to the headphone or the electronic device in the foregoing method embodiments.

This application further provides a chip system. The chip system is configured to support the headphone or the electronic device in the foregoing method embodiments in implementing the functions shown in embodiments of this application.

This application further provides a computer program product. The computer program product includes a computer program (which may also be referred to as code or instructions). When the computer program runs on a computer, the computer may perform the method corresponding to the headphone or the electronic device shown in the foregoing method embodiments.

A person of ordinary skill in the art may be aware that, in combination with the examples described in the embodiments disclosed in this specification, modules and algorithm steps can be implemented by electronic hardware or a combination of computer software and electronic hardware. Whether the functions are executed in a mode of hardware or software depends on particular applications and design constraint conditions of the technical solutions. A person skilled in the art may use different methods to implement the described functions for each particular application, but it should not be considered that the implementation goes beyond the scope of this application.

A person skilled in the art may clearly understand that, for the objective of convenient and brief description, for a detailed working process of the system, apparatus, and module described above, refer to a corresponding process in the method embodiments, and details are not described herein again.

In the several embodiments provided in this application, it should be understood that the disclosed system, apparatus, and method may be implemented in other manners. For example, the foregoing described apparatus embodiment is merely an example. For example, the module division is merely logical function division and may be other division during actual implementation. For example, a plurality of modules or components may be combined or integrated into another system, or some features may be ignored or not performed. In addition, the displayed or discussed mutual couplings or direct couplings or communication connections may be implemented by using some interfaces. The indirect couplings or communication connections between the apparatuses or modules may be implemented in electronic, mechanical, or other forms.

The modules described as separate parts may or may not be physically separate, and parts displayed as modules may or may not be physical modules, may be located in one position, or may be distributed on a plurality of network modules. Some or all of the modules may be selected according to actual needs to achieve the objectives of the solutions of the embodiments.

In addition, functional modules in embodiments of this application may be integrated into one processing module, or each of the modules may exist alone physically, or two or more modules may be integrated into one module.

If implemented in a form of a software functional module and sold or used as an independent product, the functions may be stored in a computer-readable storage medium. Based on such an understanding, the technical solutions of this application essentially, or the part contributing to the conventional technology, or a part of the technical solutions may be implemented in a form of a software product. The computer software product is stored in a storage medium, and includes several instructions for instructing a computer device (which may be a personal computer, a server, a network device, or the like) to perform all or some of the steps of the methods described in embodiments of this application. The storage medium includes: any medium that can store program code, such as a USB flash drive, a removable hard disk, a read-only memory (read-only memory, ROM), a random access memory (random access memory, RAM), a magnetic disk, a compact disc, or the like.

The foregoing descriptions are merely specific implementations of this application, but are not intended to limit the protection scope of embodiments of this application. Any variation or replacement readily figured out by a person skilled in the art within the technical scope disclosed in embodiments of this application shall fall within the protection scope of embodiments of this application. Therefore, the protection scope of embodiments of this application shall be subject to the protection scope of the claims.

1. A headphone sound effect compensation method, applied to a headphone, wherein the headphone is in a connected state with an electronic device, and the headphone stores a headphone sound effect compensation parameter corresponding to the headphone; and
the method comprises:
sending, by the headphone, the headphone sound effect compensation parameter to the electronic device if the electronic device has a headphone sound effect compensation function, wherein the headphone sound effect compensation parameter is used to perform headphone sound effect compensation on audio played by a user.

2. The method according to claim 1, wherein before the sending, by the headphone, the headphone sound effect compensation parameter to the electronic device, the method further comprises:
sending, by the headphone, first information to the electronic device, wherein the first information indicates that the headphone has a capability of reporting the headphone sound effect compensation parameter; and
receiving, by the headphone, second information from the electronic device, wherein the second information is used to request the headphone sound effect compensation parameter.

3. The method according to claim 1, wherein the electronic device has the headphone sound effect compensation function, and the method comprises:
sending, by the headphone, a first command to the electronic device, wherein the first command is used to query whether the electronic device has the headphone sound effect compensation function.

4. The method according to claim 1, wherein the sending, by the headphone, the headphone sound effect compensation parameter to the electronic device comprises:
sending, by the headphone, the headphone sound effect compensation parameter to the electronic device if a first control is in an on state, wherein the first control is configured to control enabling or disabling of the headphone sound effect compensation function.

5. The method according to claim 1, wherein the method further comprises:
receiving, by the headphone, third information from the electronic device, wherein the third information is used to request head motion tracking data, and the head motion tracking data is used to perform sound effect rendering on the audio; and
sending, by the headphone, the head motion tracking data to the electronic device based on the third information.

6. The method according to claim 1, wherein the method further comprises:
receiving, by the headphone, fourth information from the electronic device, wherein the fourth information is used to request angular velocity data and acceleration data of the headphone, and the angular velocity data and the acceleration data are used to perform sound effect rendering on the audio; and
sending, by the headphone, the angular velocity data and the acceleration data to the electronic device based on the fourth information.

7. The method according to claim 1, wherein the method further comprises:
if the electronic device does not have the headphone sound effect compensation function, receiving, by the headphone, the audio from the electronic device, wherein the audio is obtained by the electronic device in response to an operation of triggering playing the audio by the user; and
performing, by the headphone, headphone sound effect compensation on the audio based on the headphone sound effect compensation parameter.

8. A headphone sound effect compensation method, applied to an electronic device, wherein the electronic device is in a connected state with a headphone, and the headphone stores a headphone sound effect compensation parameter corresponding to the headphone; and
the method comprises:
receiving, by the electronic device, the headphone sound effect compensation parameter from the headphone if the electronic device has a headphone sound effect compensation function; and
performing, by the electronic device based on the headphone sound effect compensation parameter in response to an operation of triggering playing audio by a user, headphone sound effect compensation on the audio played by the user.

9. The method according to claim 8, wherein before the receiving, by the electronic device, the headphone sound effect compensation parameter from the headphone, the method further comprises:
receiving, by the electronic device, first information from the headphone, wherein the first information indicates that the headphone has a capability of reporting the headphone sound effect compensation parameter; and
sending, by the electronic device, second information to the headphone based on the first information, wherein the second information is used to request the headphone sound effect compensation parameter.

10. The method according to claim 8, wherein the electronic device has the headphone sound effect compensation function, and the method comprises:
receiving, by the electronic device, a first command from the headphone, wherein the first command is used to query whether the electronic device has the headphone sound effect compensation function.

11. The method according claim 8, wherein the receiving, by the electronic device, the headphone sound effect compensation parameter from the headphone comprises:
receiving, by the electronic device, the headphone sound effect compensation parameter from the headphone if a first control is in an on state, wherein the first control is configured to control enabling or disabling of the headphone sound effect compensation function.

12. The method according to claim 8, wherein the method further comprises:
obtaining, by the electronic device, head motion tracking data of the user in response to the operation of triggering playing the audio by the user;
obtaining, by the electronic device, relative motion data between the electronic device and a head of the user based on the head motion tracking data; and
performing, by the electronic device based on the relative motion data between the electronic device and the head of the user, sound effect rendering on the audio played by the user.

13. The method according to claim 12, wherein the obtaining head motion tracking data of the user comprises:
sending, by the electronic device, third information to the headphone, wherein the third information is used to request the head motion tracking data; and
receiving, by the electronic device, the head motion tracking data from the headphone.

14. The method according to claim 12, wherein the obtaining head motion tracking data of the user comprises:
sending, by the electronic device, fourth information to the headphone, wherein the fourth information is used to request angular velocity data and acceleration data of the headphone;
receiving, by the electronic device, the angular velocity data and the acceleration data from the headphone; and
determining, by the electronic device, the head motion tracking data based on the angular velocity data and the acceleration data.

15. The method according to claim 12, wherein the obtaining head motion tracking data of the user comprises:
obtaining, by the electronic device, the head motion tracking data of the user if a second control is in the on state, wherein the second control is configured to control whether to obtain the head motion tracking data.

16. The method according to claim 8, wherein the method further comprises:
if the electronic device does not have the headphone sound effect compensation function, sending, by the electronic device to the headphone in response to the operation of triggering playing the audio by the user, the audio played by the user.

17. A headphone sound effect compensation method, applied to a communication system comprising an electronic device and a headphone, wherein the electronic device is in a connected state with the headphone, and the headphone stores a headphone sound effect compensation parameter corresponding to the headphone; and
the method comprises:
sending, by the headphone, first information to the electronic device if the electronic device has a headphone sound effect compensation function, wherein the first information indicates that the headphone has a capability of reporting the headphone sound effect compensation parameter;
sending, by the electronic device, second information to the headphone based on the first information, wherein the second information is used to request the headphone sound effect compensation parameter;
receiving, by the headphone, the second information, and sending, based on the first information, the headphone sound effect compensation parameter to the electronic device;
receiving, by the electronic device, the headphone sound effect compensation parameter; and
performing, by the electronic device based on the headphone sound effect compensation parameter in response to an operation of triggering playing audio by a user, headphone sound effect compensation on the audio played by the user.

18. The method according to claim 17, wherein the method further comprises:
if the electronic device does not have the headphone sound effect compensation function, sending, by the electronic device to the headphone in response to an operation of triggering playing audio by a user, the audio played by the user;
receiving, by the headphone, the audio; and
performing, by the headphone, headphone sound effect compensation on the audio based on the headphone sound effect compensation parameter.

19-40. (canceled)

41. The method according to claim 4, wherein the method further comprises:
receiving, by the headphone, third information from the electronic device, wherein the third information is used to request head motion tracking data, and the head motion tracking data is used to perform sound effect rendering on the audio; and
sending, by the headphone, the head motion tracking data to the electronic device based on the third information.

42. The method according to claim 11, wherein the method further comprises:
obtaining, by the electronic device, head motion tracking data of the user in response to the operation of triggering playing the audio by the user;
obtaining, by the electronic device, relative motion data between the electronic device and a head of the user based on the head motion tracking data; and
performing, by the electronic device based on the relative motion data between the electronic device and the head of the user, sound effect rendering on the audio played by the user.
